(19) United States
(12) Patent Application Publication
(10) Pub. No.: US 2015/0046248 A1
(43) Pub. Date: Feb. 12, 2015

(54) CAMPAIGN MANAGER

(71) Applicant: CATCH MEDIA, INC., Douglasville, GA (US)

(72) Inventors: Yaacov Ben-Yaacov, Douglasville, GA (US); Boaz Ben-Yaacov, Douglasville, GA (US); Abraham Lieberman, Modi'in (IL)

(21) Appl. No.: 14/371,431

(22) PCT Filed: Dec. 21, 2012
(86) PCT No.: PCT/US12/71515

§ 371 Date: Jul. 9, 2014

Related U.S. Application Data
(60) Provisional application No. 61/584,319, filed on Jan. 9, 2012.

(51) Int. Cl. G06Q 30/02

(52) U.S. Cl. CPC G06Q 30/0242; G06Q 30/0276
USPC 705/14.41

(57) ABSTRACT

A campaign management system, including tracking interfaces for enabling third parties to provide consumer media-related tracking data, a tracking database, coupled with the tracking interfaces, for storing and managing data received via the tracking interfaces, a campaign generator for generating campaigns, including content interfaces to content management systems, a generation tool for identifying content for use in a campaign via the content interfaces, and for defining a campaign in terms of the identified content, and a rule tool for defining rules for campaigns in terms of tracking data, a campaign database, coupled with the campaign generator, for storing campaigns that have been generated, a rules database, coupled with the campaign generator, for storing and managing rules governing distribution of campaigns, and a campaign distributor, coupled with the campaign database, the rules database and the tracking database, for distributing campaigns in the campaign database to client media devices in accordance with rules in the rules database and tracking data in the tracking database.

### FIELD OF THE INVENTION

The present invention relates to post-acquisition media-related campaigns.

### SUMMARY OF THE DESCRIPTION

Aspects of the present invention relate to methods and systems for enabling post-acquisition revenues for digital assets, by providing the technology infra-structure for a wide variety of post-acquisition services. Post-acquisition revenues refer to revenues generated from consumers after their initial purchase of their digital assets. The post-acquisition revenue is allocated between publishers, e-tailers and consumers, and as such represents an opportunity and an incentive for these participants to generate additional revenue from digital assets that have already been sold.

One such post-acquisition revenue opportunity is a market for used digital assets, referred to herein as “e-used assets”. The term “e-used” is an anomaly, since digital assets do not have wear and tear. Aspects of the present invention provide a comprehensive e-commerce system for reselling digital assets, and for lending digital assets.

For example, aspects of the present invention provide a mechanism for supporting an e-used book market. The present invention enables a second tier for electronic books (“e-books”), wherein e-books can be resold. The second tier enables publishers to control the e-used book market, and to re-monetize an e-book multiple times, after the initial sale of the e-book. The second tier also enables publishers to market the e-book across multiple e-tailers, instead of being limited to the one e-tailer who provides the initial sales. The present invention enables consumers to sell their purchased e-books to other consumers across multiple e-tailers.

Embodiments of the present invention provide a registry of registries, across multiple e-tailers, for initial purchases of digital assets and for subsequent purchases of e-used digital assets. Embodiments of the present invention track sale and resale transactions, and act as a clearinghouse for disparate vendors.

Another such post-acquisition revenue opportunity is providing mobile access to a consumer's digital assets, so that a consumer has access to his entire digital asset collections regardless of his location. Aspects of the present invention provide a comprehensive system for registering, managing, tracking and provisioning of digital assets.

Yet another such post-acquisition revenue opportunity is providing insurance for digital asset collections. Aspects of the present provide methods and systems for accurately tracking and appraising a media inventory, and for processing insurance claims for lost or stolen media.

Yet another such post-acquisition revenue opportunity is advertising campaigns based on tracking data. Aspects of the present invention provide a campaign manager in the form of a system that provisions “campaign content” to a “device platform” based on “rules”. The campaign content includes static media, interactive media, or interactive applications. Campaign content may be provisioned once, or may be provisioned in subscription form; e.g., every x days/weeks/months, for y times, campaign content may be pushed to target devices based on the rules. The device platforms include any application, whether PC, mobile, web or embedded. The rules are based on criteria including properties of the device or platform that the campaign content is provisioned to, based on media-related or non-media-related tracking data for a consumer. As such, campaigns are provisioned based on any aspect of a consumer's “media universe”—inter alia what he owns, what he consumes, what he shares, what he borrows, when he consumes, how much he consumes, and on what devices or apps he does this.

Consumption data from within the campaigns is also tracked and is fed back into the campaign rules system. As such, interactions a consumer has had in the past with a campaign can drive additional campaigns. Interaction may be viewing (impressions), clicking through, consuming media, clicking out to external sites, or purchasing.

The present invention is of advantage to consumers, who invest substantial money in accumulating personal media collections, by providing them with an accurate registry of their media items and the rights they have thereto, and enabling them to insure their collections against loss and theft. The present invention is also of advantage to insurance companies, by enabling them to insure people's valuable media inventories with accurate appraisal value, and to process claims for lost or stolen media items.

Moreover, the present invention also provides insurers with an easy mechanism to replace lost or stolen media collections. Media may be replaced in the same physical or non-physical form that it had prior to loss or theft; i.e., physical CDs are replaced with physical CDs and computer media files are replaced with computer media files.

There is thus provided in accordance with an embodiment of the present invention a campaign management system, including tracking interfaces for enabling third parties to provide consumer media-related tracking data, a tracking database, coupled with the tracking interfaces, for storing and managing data received via the tracking interfaces, a campaign generator for generating campaigns, including content interfaces to content management systems, a generation tool for identifying content for use in a campaign via the content interfaces, and for defining a campaign in terms of the identified content, and a rule tool for defining rules for campaigns in terms of tracking data, a campaign database, coupled with the campaign generator, for storing campaigns that have been generated, a rules database, coupled with the campaign generator, for storing and managing rules governing distribution of campaigns, and a campaign distributor, coupled with the campaign database, the rules database and the tracking database, for distributing campaigns in the campaign database to client media devices in accordance with rules in the rules database and tracking data in the tracking database.

There is also provided in accordance with an embodiment of the present invention a method for managing provision of campaigns to consumer media devices, including obtaining media-related tracking data, storing the obtained tracking data in a tracking database, identifying content for use in a campaign, from one or more content management systems, defining a campaign in terms of the identified content, storing the defined campaign in a campaign database, specifying campaign distribution rules in terms of tracking data, storing the specified distribution rules in a rules database, and distributing campaigns stored in the campaign database to client media devices, in accordance with rules stored in the rules database and tracking data stored in the tracking database.

### BRIEF DESCRIPTION OF THE DRAWINGS

The present invention will be more fully understood and appreciated from the following detailed description, taken in conjunction with the drawings in which:

FIG. 1 is a simplified block diagram of eleven components of a content provisioning and revenue disbursement system, in accordance with an embodiment of the present invention;

FIG. 2 is a simplified flowchart of a process for content identification, in accordance with an embodiment of the present invention;

FIG. 3 is a simplified flowchart of a process for mapping consumer data to a consumer namespace, in accordance with an embodiment of the present invention;

FIG. 4 is a diagram illustrating namespace mapping for a consumer, in accordance with an embodiment of the present invention;

FIG. 5 is a simplified flowchart for a process of mapping content data to a content namespace, in accordance with an embodiment of the present invention;

FIG. 6 is a simplified flowchart of a process of registering devices and content to a consumer, in accordance with an embodiment of the present invention;

FIGS. 7A and 7B are diagrams illustrating a system that registers consumer music and video content, respectively, originating from CDs and other physical media, and consumer music and video content, respectively, downloaded via the Internet and over the air, in accordance with an embodiment of the present invention;

FIGS. 8A and 8B are diagrams illustrating registration of a household's music and videos, respectively, in accordance with an embodiment of the present invention;

FIG. 9 is a diagram illustrating registration of household player devices, in accordance with an embodiment of the present invention;

FIG. 10 is a simplified flowchart for a process of content routing and media playback, in accordance with an embodiment of the present invention;

FIG. 11 is a diagram illustrating music and video content routing from a multitude of content providers to a multitude of player devices, in accordance with an embodiment of the present invention;

FIG. 12, which is a simplified flowchart of a process of registering a consumer's inventory, retrieval and display of inventory on a player device, and playback of media on a player device, in accordance with an embodiment of the present invention;

FIG. 13 is a simplified flowchart of a process of tracking consumer acquisition of media, playback of media, and associations between media items, in accordance with an embodiment of the present invention;

FIG. 14 is a simplified flowchart of a process of associating items of media with one another, in accordance with an embodiment of the present invention;

FIG. 15 is a simplified flowchart of a process of validating and enforcing consumer rights to media, in accordance with an embodiment of the present invention;

FIG. 16 is a simplified block diagram of a content provisioning and subscription revenue disbursement system, in accordance with an embodiment of the present invention;

FIG. 17A is a diagram illustrating subscription revenue sharing between content owners, content distributors, service providers and registrants, in accordance with an embodiment of the present invention;

FIG. 17B is an illustration of an accounting report for distributing the share allocated in FIG. 17A to the content owners, among a plurality of content owners, in accordance with an embodiment of the present invention;

FIG. 18 is a summary diagram of vendors in the content purchase and supply chain, integrated within a content licensing service, in accordance with an embodiment of the present invention;

FIGS. 19A and 19B are simplified illustrations of a first consumer use case of acquiring content, in accordance with an embodiment of the present invention;

FIGS. 20A and 20B are simplified illustrations of a second consumer use case of acquiring content, in accordance with an embodiment of the present invention;

FIGS. 21A, 21B and 21C are simplified illustrations of a third consumer use case of acquiring content, in accordance with an embodiment of the present invention;

FIG. 22 is a simplified high-level architecture diagram of a content provisioning and revenue disbursement system, in accordance with an embodiment of the present invention;

FIG. 23 is a simplified architecture diagram of an SDK that is provided with the system of FIG. 22, in accordance with an embodiment of the present invention;

FIG. 24 is a simplified architecture diagram of a web services layer for the system of FIG. 22, in accordance with an embodiment of the present invention;

FIG. 25 is a simplified architecture diagram of engine and database layers for the system of FIG. 22, in accordance with an embodiment of the present invention;

FIG. 26 is a simplified architecture diagram of a back end node for the system of FIG. 22, in accordance with an embodiment of the present invention;

FIG. 27 is a simplified block diagram of a system for appraising a media inventory, in accordance with an embodiment of the present invention;

FIG. 28 is a simplified block diagram of a system for insuring a media inventory, in accordance with an embodiment of the present invention;

FIG. 29 is a simplified flowchart of a method for appraising a media inventory, in accordance with an embodiment of the present invention;

FIG. 30 is a simplified flowchart of a method for insuring a media inventory, in accordance with an embodiment of the present invention;

FIG. 31 is an illustration of participants in a two-tier e-commerce system for selling e-books, in accordance with an embodiment of the present invention;

FIG. 32 is a simplified block diagram of a system for resale of digital assets, in accordance with an embodiment of the present invention;

FIG. 33 is a simplified flowchart of a method for resale of digital assets, in accordance with an embodiment of the present invention;

FIG. 34 is a simplified block diagram of a system for lending of digital assets, in accordance with an embodiment of the present invention;

FIG. 35 is a simplified flowchart of a method for lending digital assets, in accordance with an embodiment of the present invention;

FIG. 36 is a simplified block diagram of a system for determining a market price for a digital asset, in accordance with an embodiment of the present invention;

FIG. 37 is a simplified flowchart of a method for determining a market price for a digital asset, in accordance with an embodiment of the present invention;

FIG. 38 is a simplified block diagram of a campaign manager for provisioning campaign content from content sources to device platforms, in accordance with an embodiment of the present invention; and

FIG. 39 is a flowchart of a method for managing provision of campaign content from content sources to device platforms, in accordance with an embodiment of the present invention.

The following definitions are employed throughout the specification.

CONTENT/DIGITAL ASSET—digital media including inter alia music, video, e-books, games and software applications.
CONTENT MAPPING—determining for a designated piece of content and for a designated content media format, one or more IDs for uniquely identifying the designated piece of content.
CONTENT ROUTING—determining an appropriate source from which to transmit designated content to a player device.
MEDIA SERVER—a computer server that archives and provisions media.
NAMESPACE—a range of identifiers that are associated uniquely with items, where items may be inter alia media content, player devices, consumers and households.
PLAYER DEVICE—a media player including inter alia home entertainment systems, mobile phones, portable media players, software applications such as PC applications, and automobile decks.
PLAYLIST—a sequence of pieces of content for playing on a player device.
RECORDER DEVICE—a media recorder, including inter alia home entertainment systems, computers, audio recorders, video recorders and digital television recorders.
REGISTRY—a central data store where users' inventories are listed.
TRACKING SERVER—a computer server that tracks content-related events, including inter alia playbacks and purchases.

### DETAILED DESCRIPTION

Embodiments of the present invention provide an end-to-end media content provisioning system that enables a consumer to access his entire content collections and subscriptions, at any location where he may be. From the consumer's perspective, he has access to a virtual replica of his content archive, his content broadcast stations, and his content playlists, at his home, in his car, in his hotel room, and wherever he travels. His content archive is presented to him in an organized way for browsing and for access via any of a plurality of player devices, including inter alia his home entertainment systems, his media players, his cell phones, his automobile deck, a rented automobile deck, and a hotel in-room entertainment system.

Consumers typically build themselves personal libraries of digital content, which are stored on memory units such as hard disk drives and removable memory cards. Digital content may be acquired through the Internet via subscription services and a la carte purchases, via peer-to-peer exchanges, and by converting songs from a compact disc (CD) and importing them into a content library.

Licenses for digital content may be acquired through several channels, including inter alia
(i) content purchased at a retail outlet store;
(ii) content purchased via the Internet from an online retailer;
(iii) content recorded onto a recorder device from broadcast, off-the-air;
(iv) content purchased through a recorder device from a licensing authority; and
(v) content purchased through a player device from a media kiosk.
   Content for preview may be licensed from these same channels.

Digital content typically includes media data and auxiliary data, referred to as metadata, used to index the content within the consumer's library. For example, within MP3 audio files metadata is accessed through an ID3 tag, WMA audio files embed metadata within the files, and both file types can embed metadata within the filenames themselves. By indexing his content, a consumer can browse his library, search his library to find and access individual content therein, remove content and create playlists. Generally, player devices provide a user interface through which consumers view content metadata.

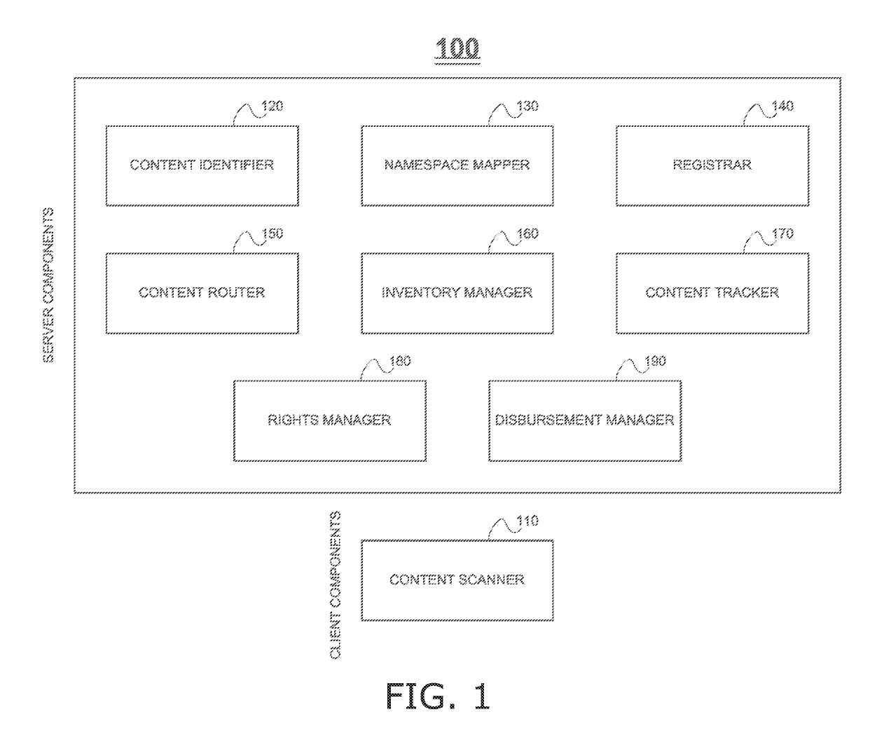

Reference is made to FIG. 1, which is a simplified block diagram of nine components of a content provisioning and revenue disbursement system 100, in accordance with an embodiment of the present invention. The components shown in FIG. 1 may be implemented in one or more server computers, in one or more client computers, or in both one or more server computers and one or more cooperating client computers. Operation of each component is described in detail hereinbelow. For ease of reference, the following table summarizes the Figures and the components of FIG. 1 that they relate to.

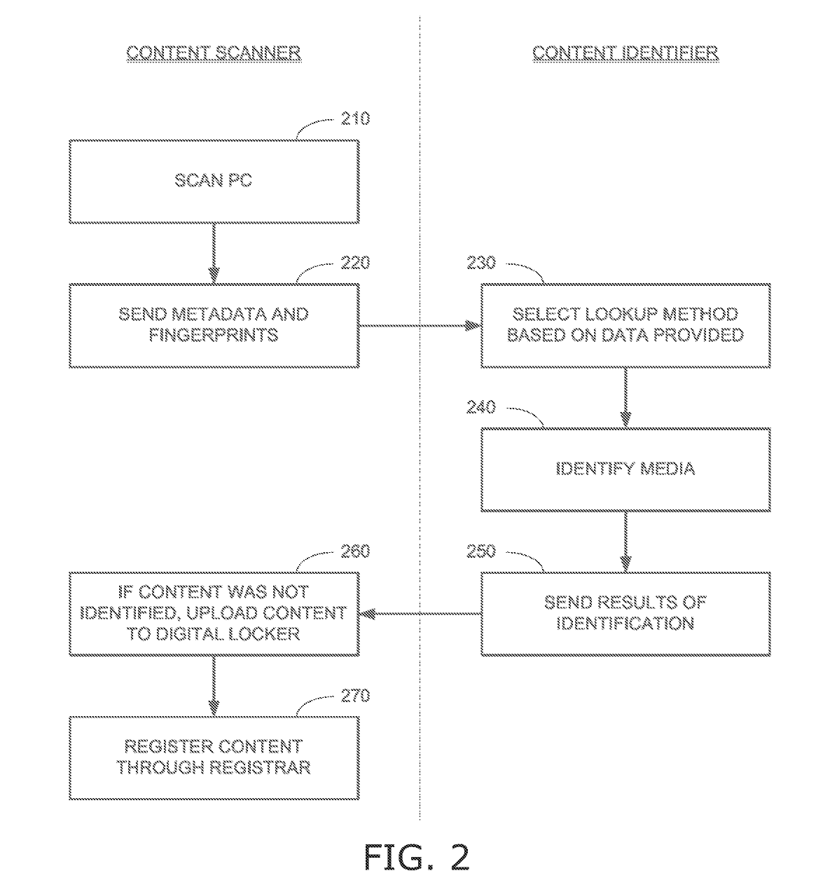

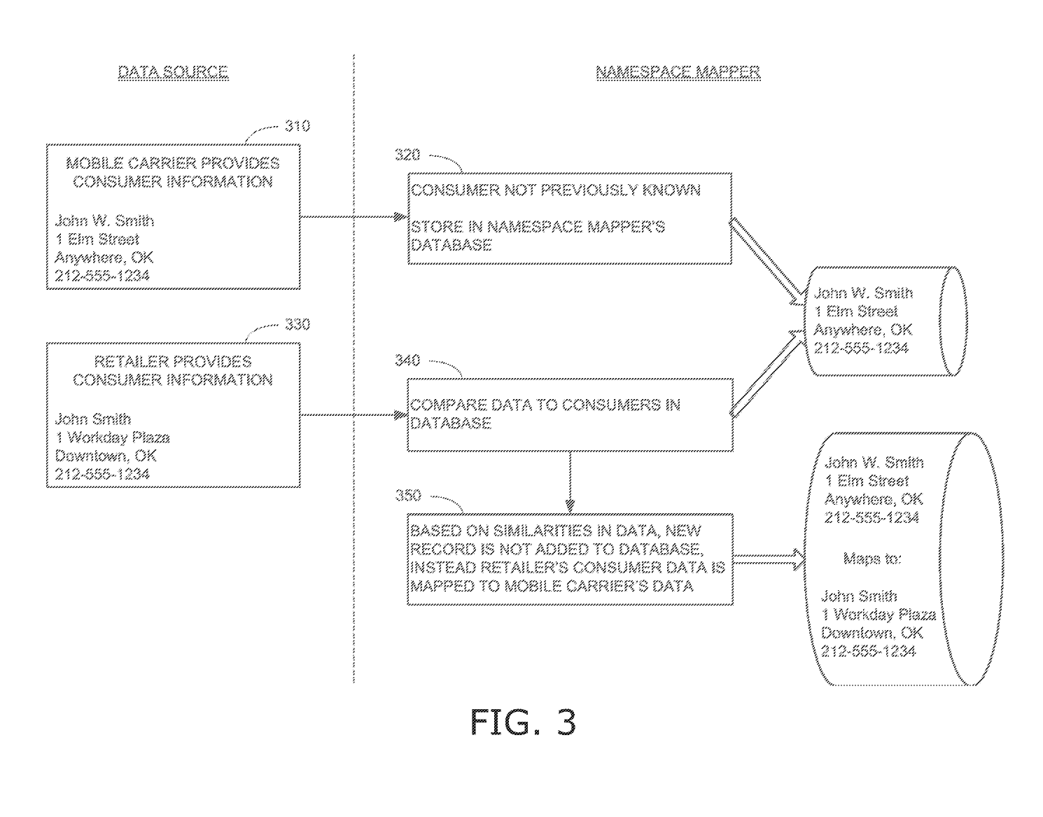

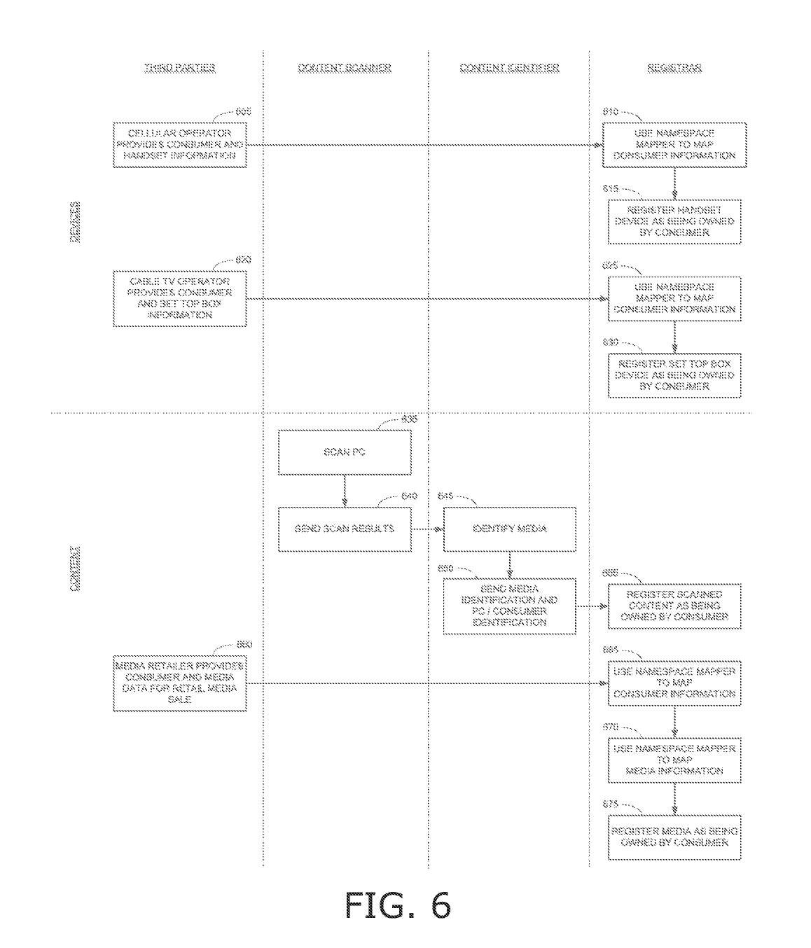

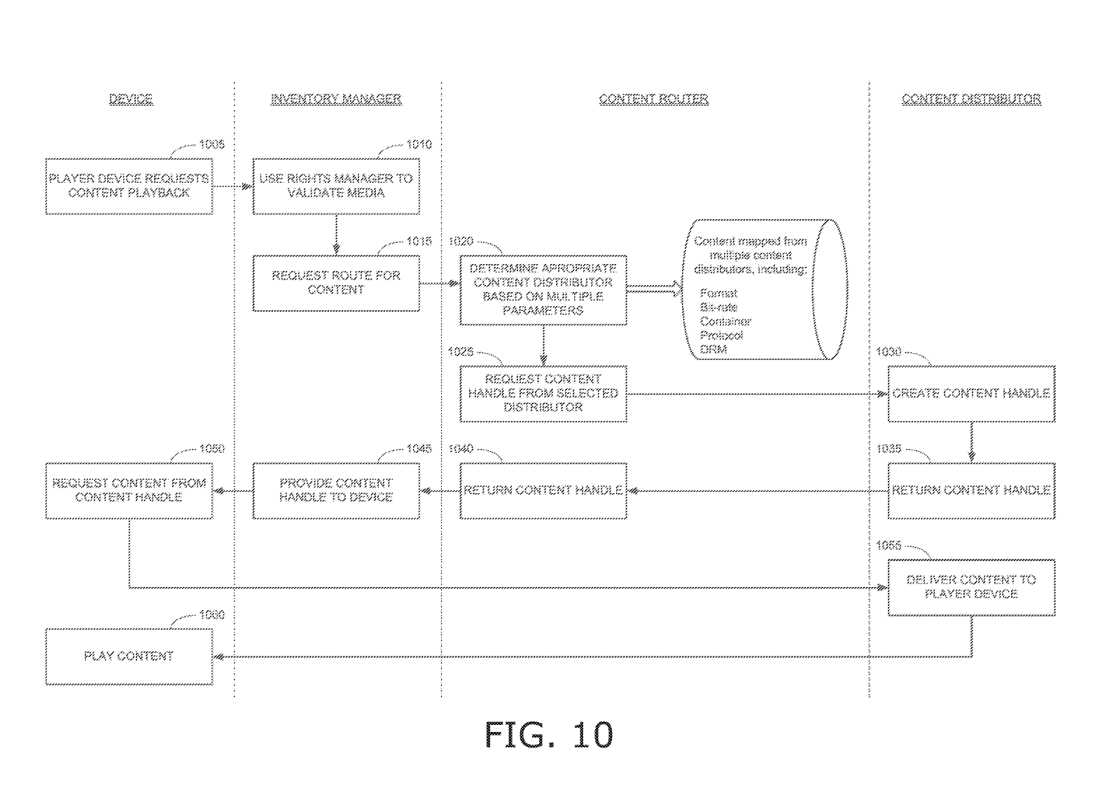

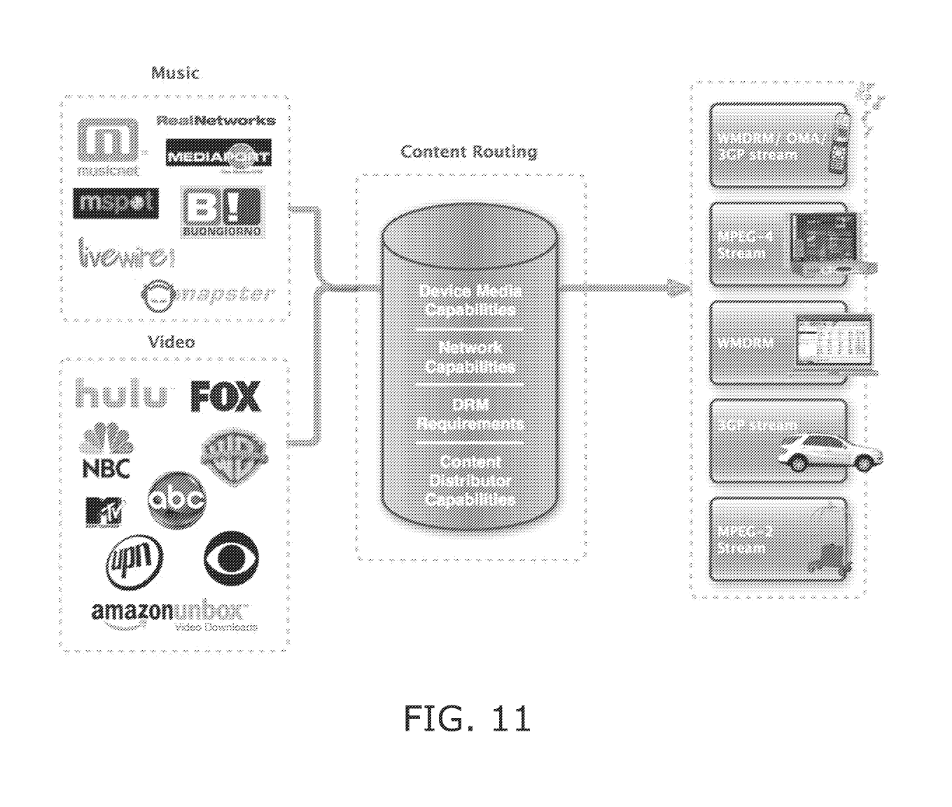

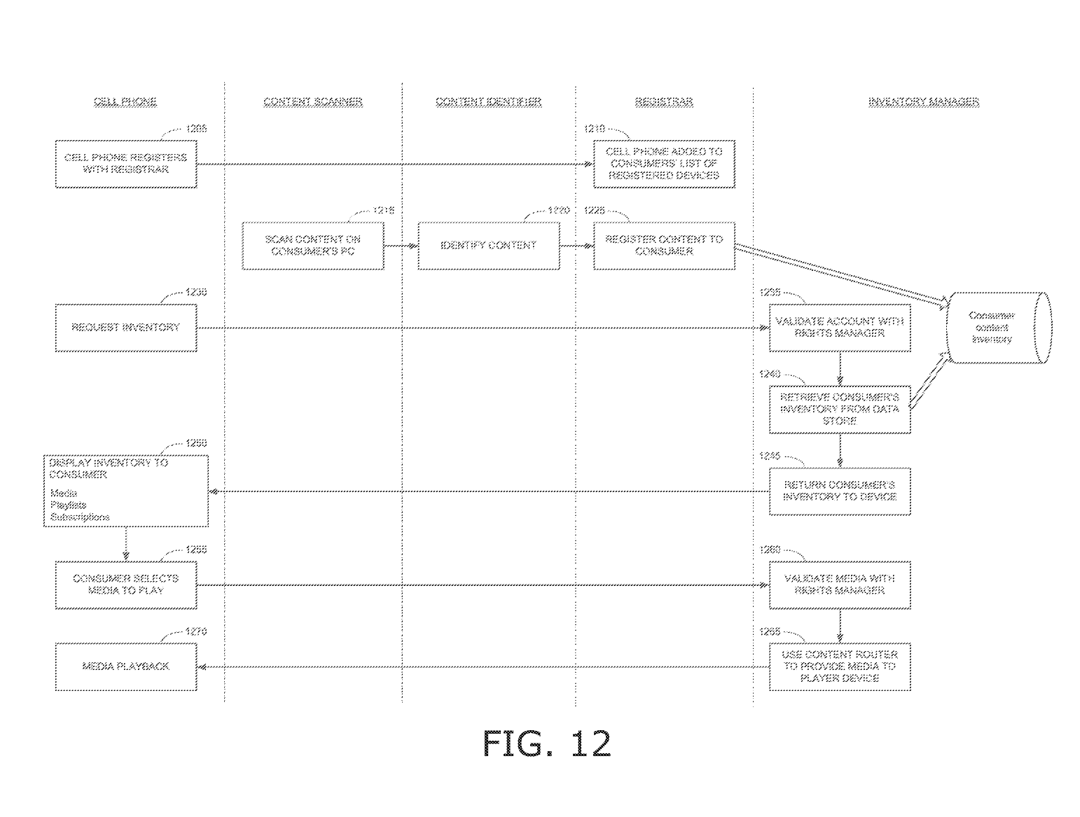

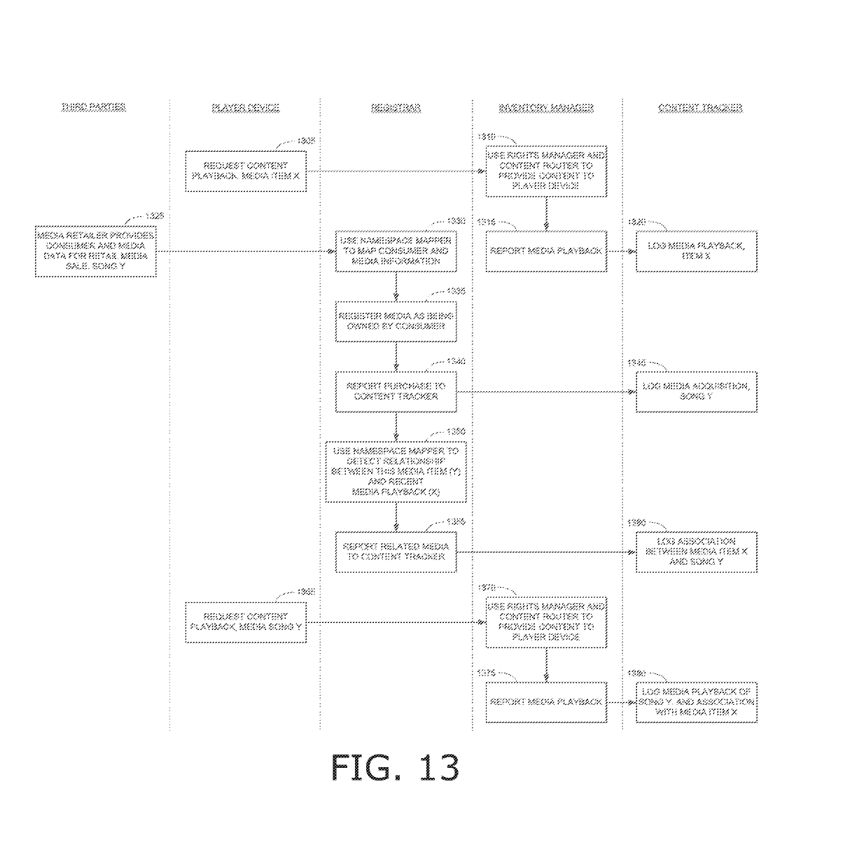

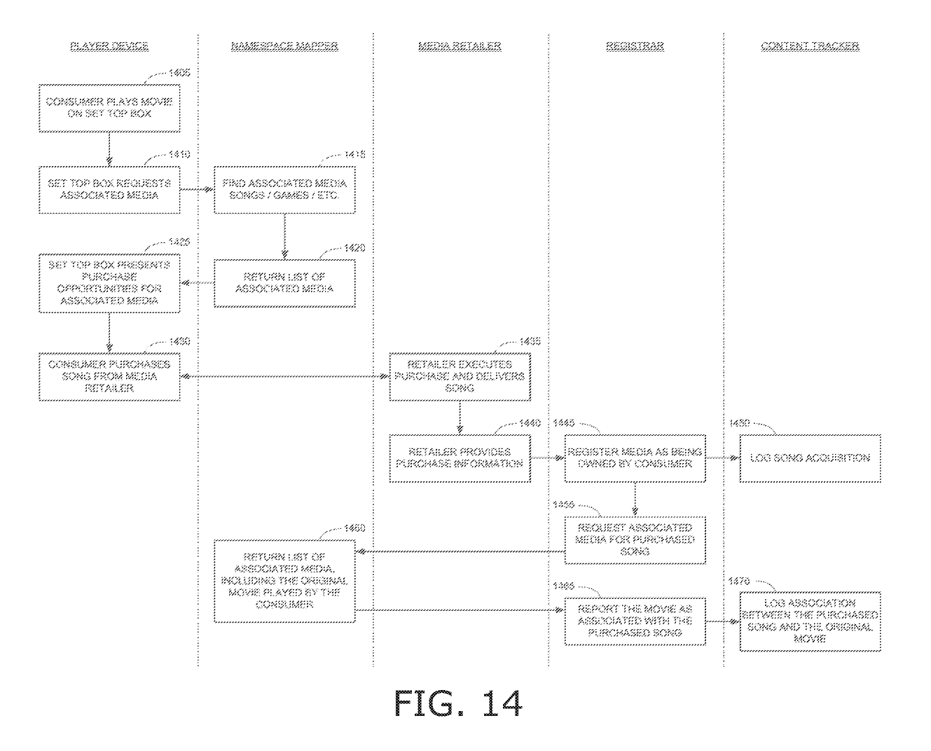

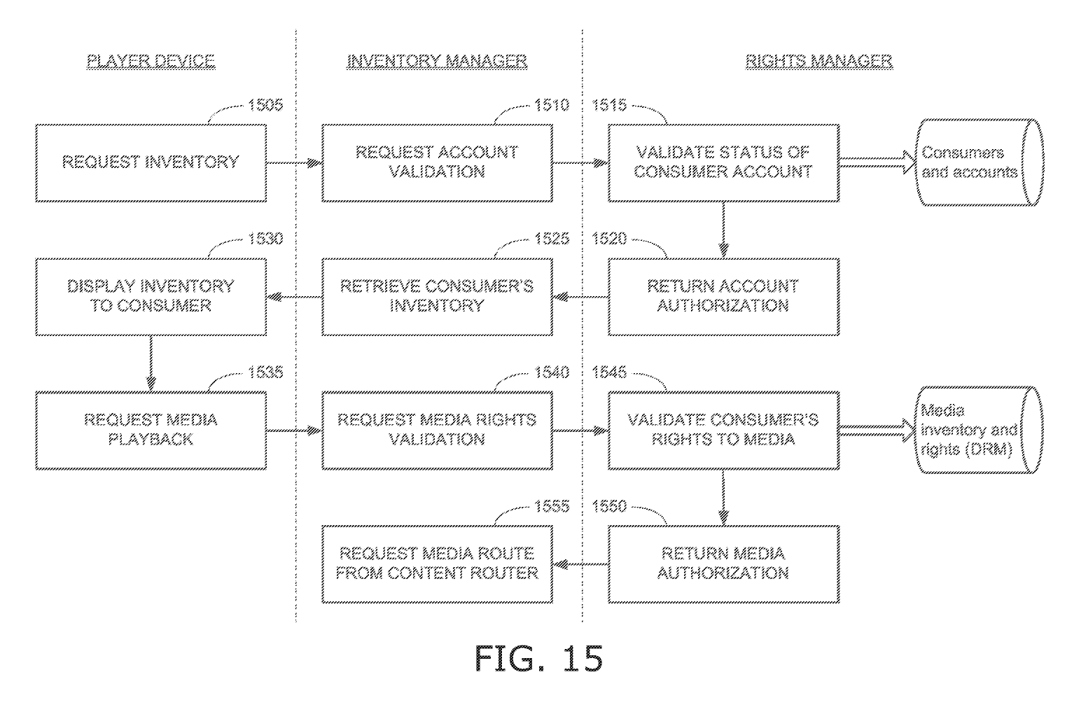

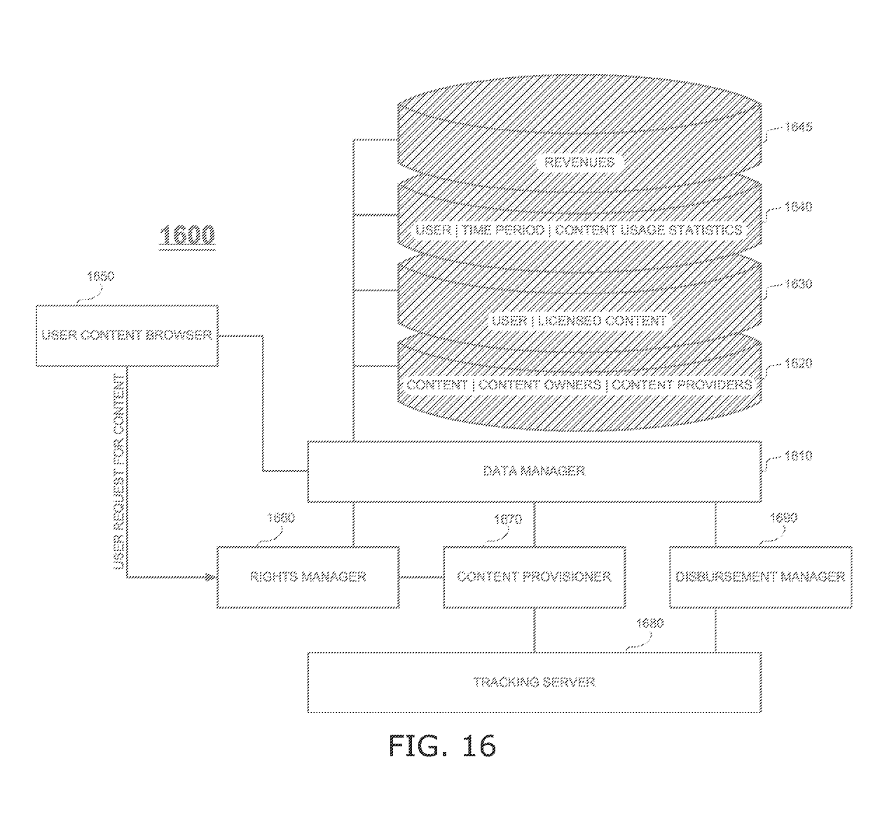

TABLE I
Summary of Figures and components that they relate to

| Component | Figure(s) |
|---|---|
| Content Scanner 110 | FIG. 2 |
| Content Identifier 120 | FIG. 2 |
| Namespace Mapper 130 | FIGS. 3-5 |
| Registrar 140 | FIGS. 6-9 |
| Content Router 150 | FIGS. 10 and 11 |
| Inventory Manager 160 | FIG. 12 |
| Content Tracker 170 | FIGS. 13 and 14 |
| Rights Manager 180 | FIG. 15 |
| Disbursement Manager 190 | FIGS. 16-18 |

### Content Scanner 110

Shown in FIG. 1 is a content scanner 110, which locates applicable media on a consumer's devices, including the consumer's content archive, playlists and content subscriptions. Content scanner 110 is generally implemented on a home PC.

Content scanner 110 scans the consumer's PCs to generate a list of IDs of content resident thereon. Content scanner 110 also scans the consumer's PCs for media archives, such as iTunes® databases, Windows Media Player databases, Napster® databases and other such player databases, and for media playlists. Content scanner 110 also scans the consumer's PCs for podcasts that the consumer subscribes to and Internet radio station preferences.

Content scanner 110 sends scanned content information to content identifier 120, to identify or validate the identity of the scanned content. Content scanner 110 may send content metadata, or an excerpt of content, or content fingerprints, to content identifier 120.

With each content ID, content scanner 110 also determines a content status, including inter alia digital rights management data for the content, and time constraints for the content. Content scanner 110 verifies that digital rights managed content have valid licenses.

Content scanner 110 may additionally transmit content to a data store, referred to as a “digital locker”, which acts as a remote backup of the consumer's content.

### Content Identifier 120

Shown in FIG. 1 is a content identifier 120, which identifies an aggregate of a consumer's entire content archive and content broadcast subscriptions. Content identifier 120 is generally implemented on a server computer. After content scanner 110 scans a consumer's PC to identify his media libraries, playlists and subscriptions, content scanner 110 sends the results to content identifier 120. Content identifier 120 identifies or validates identities of the scanned content. Content identifier 120 identifies content using a variety of methods, including inter alia lookup of content metadata in a reference database of metadata, and matching of a digital fingerprint of the media with a reference database of fingerprints.

Reference is made to FIG. 2, which is a simplified flowchart of a process for content identification, as performed by content identifier 120, in accordance with an embodiment of the present invention. The flowchart of FIG. 2 is divided into two columns. The left column indicates steps performed by a content scanner, such as content scanner 110, and the right column indicates steps performed by a content identifier, such as content identified 120.

At step 210 the content scanner scans a consumer's PC for media content that is stored therein, as described hereinabove. At step 220 the content scanner sends metadata and fingerprints for the media scanned at step 210 to the content identifier. At step 230 the content identifier selects a lookup method to identify the media, based on the data provided by the content scanner. At step 240 the content identifier identifies some or all of the media. At step 250 the content identifier sends the results of its identification at step 240 to the content scanner. At step 260 the content scanner uploads content that the content identifier was unable to identify to the digital locker. At step 270 the content scanner registers the content via registrar 140, as described in detail hereinbelow with reference to FIG. 6

### Namespace Mapper 130

Shown in FIG. 1 is a namespace mapper 130. Namespace mapper 130 is generally implemented on a server computer. A “namespace” is a range of identifiers that are associated uniquely with items, where items may be inter alia media content, player devices, consumers and households. In general, data obtained from multiple sources may not adhere to the same naming convention, and may further be inconsistent. “Namespace mapping” determines, for a designated item, one or more IDs for uniquely identifying the designated item.

In accordance with embodiments of the present invention, namespace mapper 130 aggregates information from multiple data sources, including inter alia information about media content, information about player devices, information about consumers, and information about companies and other stakeholders in the content purchase and supply chains. In order to disambiguate the information obtained from the multiple sources, namespace mapper 130 uniquely identifies data elements from the multiple sources, and associates them correctly within a centralized registry.

Namespace mapper 130 normalizes content data by mapping content to the reference data store of content used by content identifier 120. Thus content received from multiple sources with different and possibly incorrect metadata is assigned consistent and correct metadata.

Namespace mapper 130 performs namespace mapping in order to compare information obtained from two or more sources, and determine whether or not the information refers to the same entity. For example, a consumer, John W. Smith, may be identified by attributes including inter alia his name, address and cell phone number in a mobile carrier database. John purchases a CD from Best Buy, and because he is a member of Best Buy's rewards program, his purchase information is recorded in Best Buy's database. However, in the Best Buy database, John's name is listed as “John Smith”, without the middle initial, and his address is different than the address in the mobile carrier database. As such, when the consumer attributes provided by the two data sources are compared, namespace mapper 130 finds that:

Name—the names do not exactly match: John W. Smith vs. John Smith;
Address—the addresses do not match; and
Cell Phone Number—the phone numbers match.

Namespace mapper 130 assigns weights to each attribute (Name, Address, Cell Phone Number), and combines the degrees of match according to the weights in order to determine whether or not the two sets of attributes correspond to the same person. Since a cell phone number is generally unique to an individual, this attribute is assigned a high weight; and since an address may not be unique to an individual, this attribute is assigned a lower weight. As such, based on the similarity of the two names, on the discrepant addresses, and on the identical cell phone numbers, namespace mapper 130 concludes that the two sets of attributes do in fact correspond to the same person. Thus the CD purchased by John at Best Buy is registered with John W. Smith's acquired content, as described hereinbelow.

Reference is made to 3, which is a simplified flowchart of a process for mapping consumer data to a consumer namespace, as performed by namespace mapper 130, in accordance with an embodiment of the present invention. The flowchart of FIG. 3 is divided into two columns. The left column indicates steps performed by a data source, and the right column indicates steps performed by a namespace mapper, such as namespace mapper 130.

At step 310 a mobile carrier provides consumer information to system 100. The example shown in FIG. 3 relates to the above John Smith example. The carrier's information includes the name spelled as “John W. Smith”, the address “1 Elm Street, Anywhere, OK”, and the phone number “212-555-1234”. At step 320 the namespace mapper checks if this customer is already known to system 100. If not, then the namespace mapper stores the customer data as a new customer record in a data store.

At step 330 a retailer, such as Best Buy, provides consumer information to system 100. The consumer information differs from the information provided by the mobile carrier at step 310 in the spelling of the consumer's name, and in the address. At step 340 the namespace mapper checks if this customer is already known to system 100 and compares the consumer information to information stored in the data store. At step 350, based on similarities in name and telephone number as indicated above, the namespace mapper concludes that the retailer's customer information corresponds to the mobile carrier's customer information. As such, the namespace mapper does not add a new customer record to the data store, but instead maps the retailer's customer information to the already existing record with the mobile carrier's customer information.

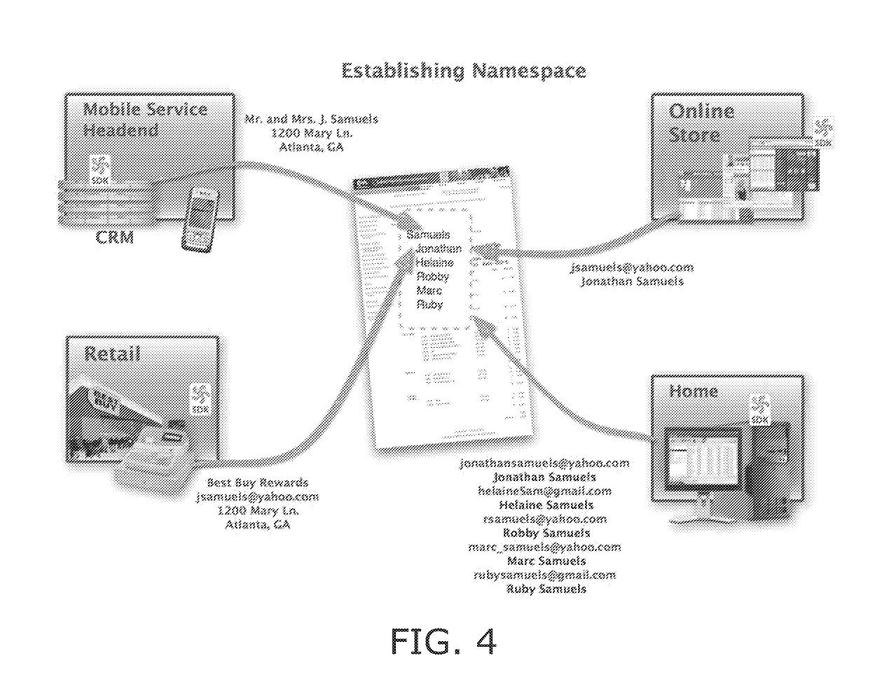

Reference is made to FIG. 4, which is a diagram illustrating namespace mapping for a consumer, in accordance with an embodiment of the present invention. Shown in FIG. 4 is information about a consumer, Jonathan Samuels, arriving from four sources of information; namely, a mobile carrier database, a Best Buy rewards program database, an online store database, and a consumer home computer file directory. The mobile carrier database provides identifying information about Jonathan Samuels, such as his name, address and cell phone number. The Best Buy database provides identifying information about content that Jonathan Samuels purchases at a Best Buy retail store. The online store database provides information about content that Jonathan Samuels purchases online. The home computer file directory provides information about content that Jonathan Samuels has stored on his home computer. In accordance with an embodiment of the present invention, the four sources are integrated in order to register all of Jonathan Samuels' content.

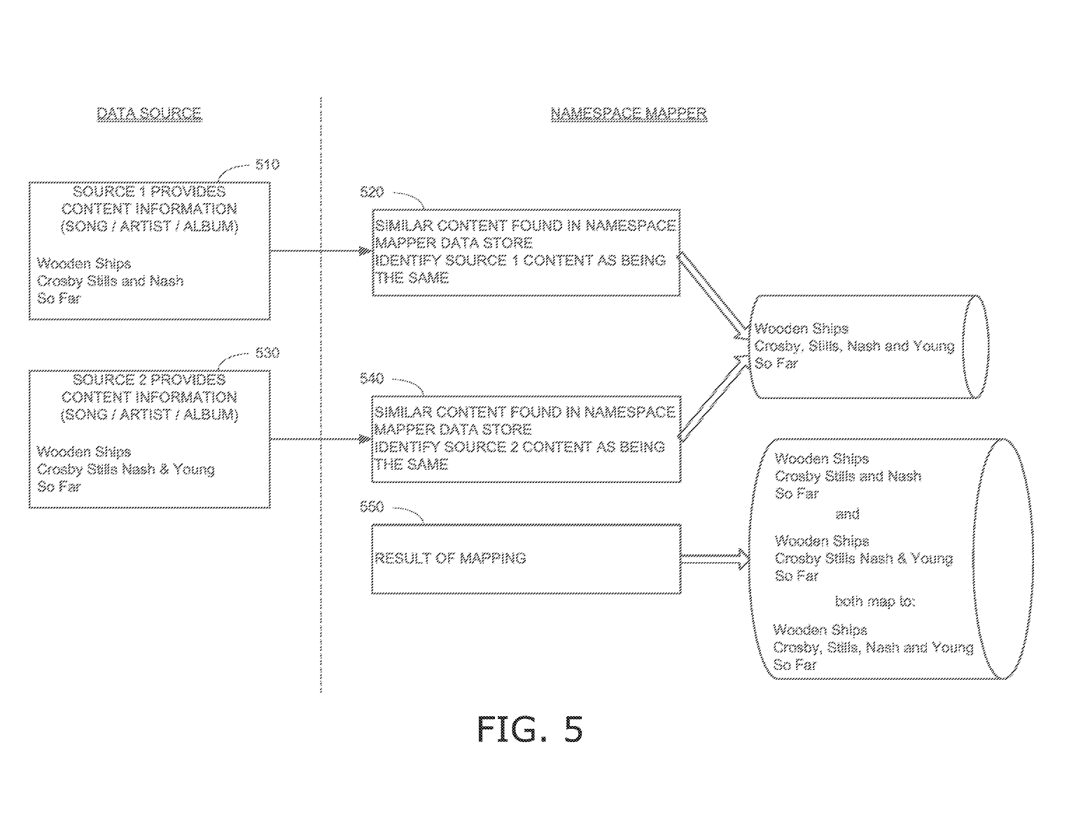

Reference is made to FIG. 5, which is a simplified flowchart for a process of mapping content data to a content namespace, as performed by namespace mapper 130, in accordance with an embodiment of the present invention. The flowchart of FIG. 5 is divided into two columns. The left column indicates steps performed by a data source, and the right column indicates steps performed by a namespace mapper, such as namespace mapper 130.

At step 510 a first data source, for example, a metadata aggregator, provides information about media content. In the example shown in FIG. 5, the information includes a song “Wooden Ships”, an artist “Crosby Stills and Nash”, and an album “So Far”. At step 520 the namespace mapper checks if the media information is already stored in a data store. For the case at hand, the data store has an already existing record with a song “Wooden Ships”, an artist “Crosby, Stills, Nash and Young”, and an album “So Far”. Based on similarities in the information, the namespace mapper concludes that the content matches similar content found in the data store, and identifies the content information received from the metadata aggregator as corresponding to the already existing record in the data store.

Similarly, at step 530 a second data source, for example, the on-line Napster® content source, provides information about media content. The information differs from the information provided by the metadata aggregator at step 510 in that the artist name is “Crosby Stills Nash & Young”, and differs from the already existing record in the data store in that the artist is punctuated “Crosby, Stills, Nash and Young”. At step 540 the namespace mapper concludes that the content matches the similar content found in the data store, and identifies the content information received from Napster as corresponding to the already existing record in the data store. At step 550 the namespace mapper has mapped both the content information received from the metadata aggregator and the content information received from Napster to the same already existing record in the data store.

### Registrar 140

Shown in FIG. 1 is a registrar 140, which registers a consumer's content, services and devices with a central data store. For each item of content registered, registrar 140 generates a content status, including inter alia digital rights management data for the content. Registrar 140 is generally implemented on a server computer.

Registrar 140 registers, to a consumer, media that was scanned by content scanner 110 and identified by content identifier 120. Additionally, registrar 140 registers, to the consumer, media that was not identified by content identifier 120, but that was instead communicated to registrar 140 by a third party such as inter alia a media store. Additionally, registrar 140 registers, to a consumer, media subscriptions and media services purchased from a third party such as inter alia a content subscription service. Additionally, registrar 140 registers player and recorder devices owned by the consumer.

Reference is made to FIG. 6, which is a simplified flowchart of a process of registering devices and content to a consumer, as performed by registrar 140, in accordance with an embodiment of the present invention. The flowchart of FIG. 6 is divided into four columns. The leftmost column indicates steps performed by third parties; the second-from-left column indicates steps performed by a content scanner, such as content scanner 110; the second-from-right column indicates steps performed by a content identifier, such as content identifier 120; and the rightmost column indicates steps performed by a registrar, such as registrar 140. Moreover, steps 605-630 relate to registration of consumer devices, and steps 635-675 relate to registration of consumer content.

At step 605 a cellular operator provides information about a consumer and his handset. At step 610 the registrar invokes namespace mapper 130 to map the consumer information to its data store, as described hereinabove with reference to FIG. 3. At step 615 the registrar registers the handset device as being owned by the consumer.

At step 620 a cable TV operator provides information about a consumer and his set top box. At step 625 the registrar invokes namespace mapper 130 to map the consumer information to its data store, as described hereinabove with reference to FIG. 3. At step 630 the registrar registers the set top box device as being owned by the consumer.

At step 635 the content scanner scans the consumer's PC for media content. At step 640 the content scanner sends the results of the scanned media content to the content identifier. At step 645 the content identifier identifies the media. At step 650 the content identifier sends the media identifiers, the consumer information and the PC information to the registrar. At step 655 the registrar registers the identified scanned content as being owned by the consumer.

At step 660 a media retailer sends consumer and media data for a retail media sale, to the registrar. At step 665 the registrar invokes namespace mapper 130 to map the consumer information to its data store, as described hereinabove with reference to FIG. 3. At step 670 the registrar invokes namespace mapper 130 to map the media data to its data store, as described hereinabove with reference to FIG. 5. At step 675 the registrar registers the media as being owned by the consumer.

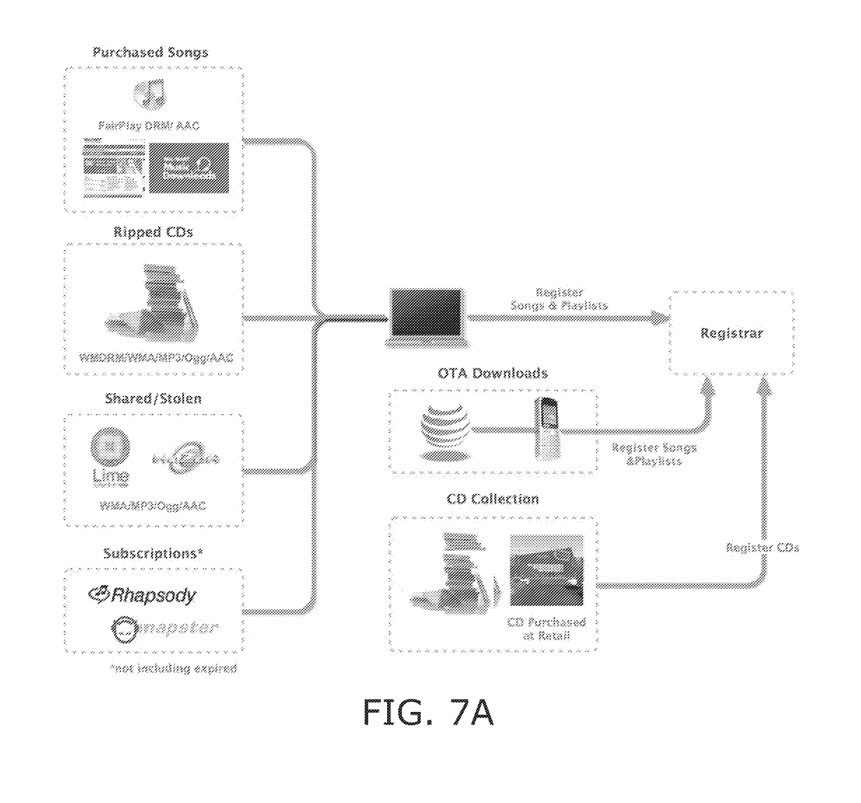

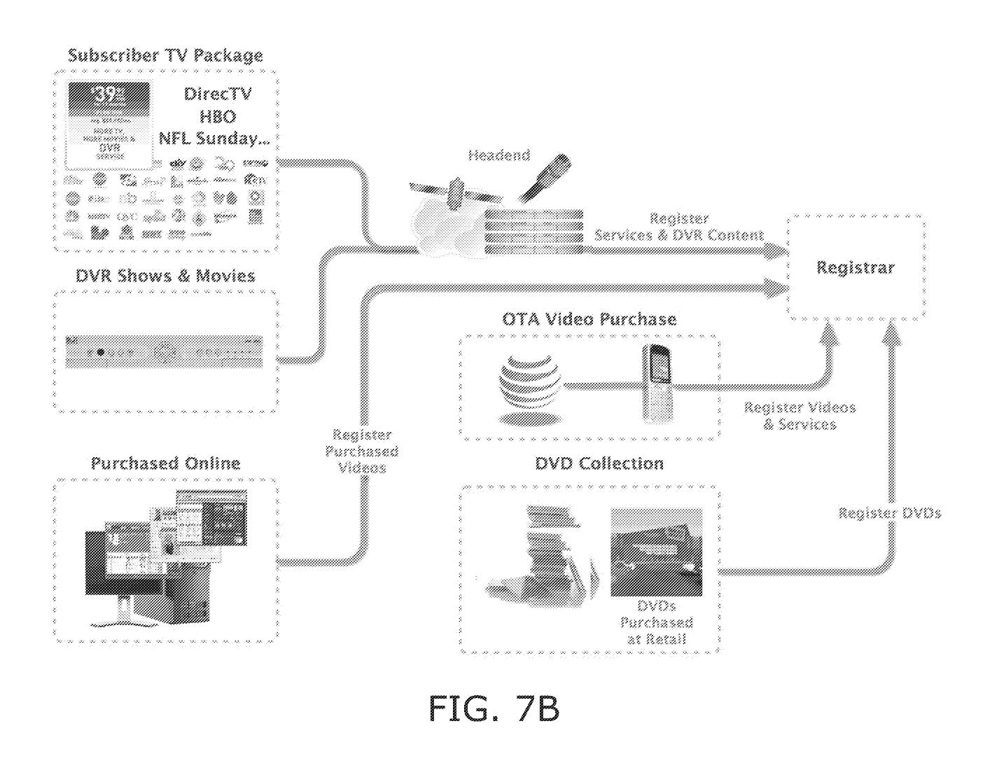

Reference is made to FIGS. 7A and 7B, which are respective diagrams illustrating a system that registers consumer content and services for music and video, respectively, originating from CDs and other physical media, downloaded via the Internet and over the air, downloaded via peer to peer networks, subscribed to via subscription services, and recorded on recorder devices, in accordance with an embodiment of the present invention.

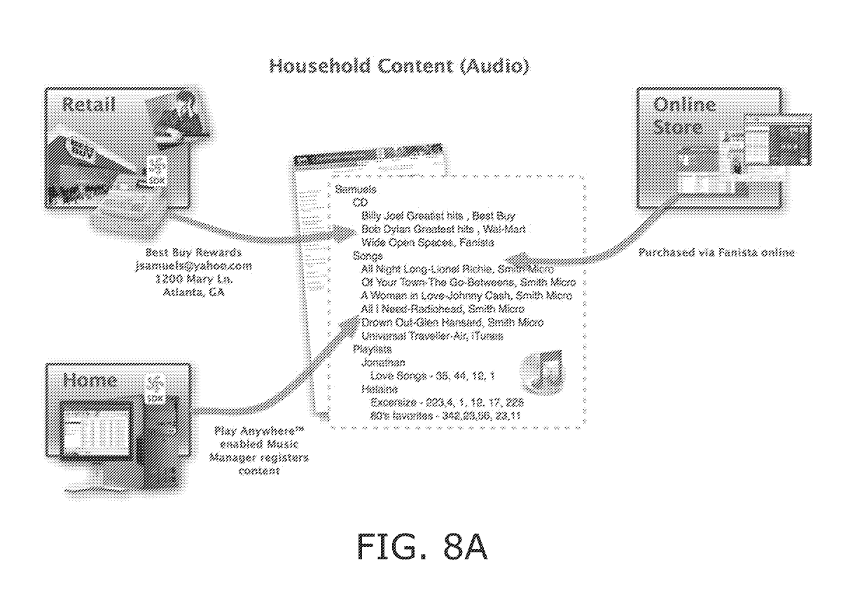

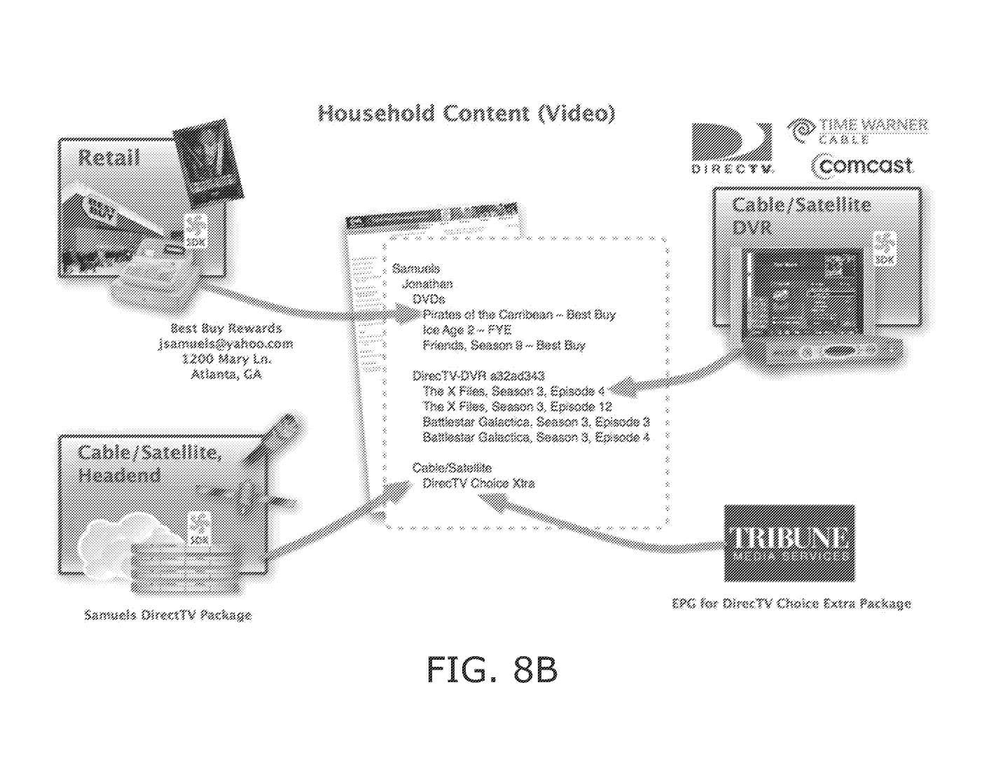

A consumer may register his entire household, which includes multiple consumer names, cell phone IDs, PC IDs, and other player device IDs. Reference is made to FIGS. 8A and 8B, which are diagrams illustrating registries of a household's music and videos, respectively, in accordance with an embodiment of the present invention. For music, FIG. SA shows registration of the Samuels' songs, CDs and playlists into a registry for the Samuels household. For video, FIG. 8B shows registration of the Samuels' DVDs, DirecTV digital video recordings (DVRs), and cable and satellite subscriptions into the registry for their household.

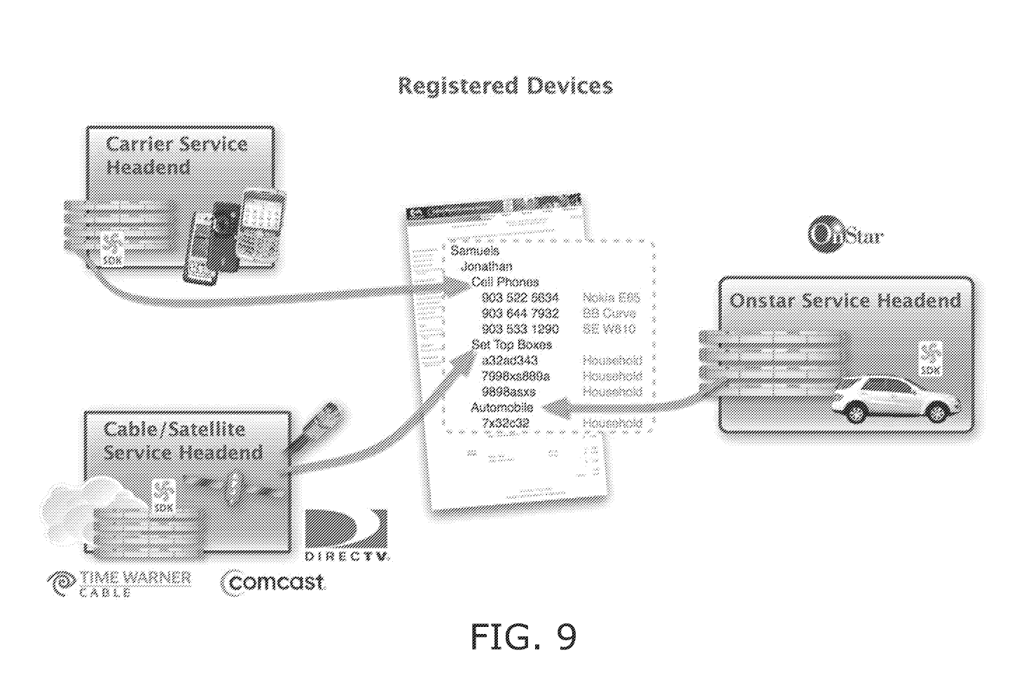

Reference is made to FIG. 9, which is a diagram illustrating a registry of household player devices, in accordance with an embodiment of the present invention. FIG. 9 shows a registry of the Samuels' household set top boxes, cell phones and automobile decks.

### Content Router 150

Shown in FIG. 1 is a content router 150. Content router 150 is generally implemented on a server computer. “Content routing” refers to determining an appropriate source from which to transmit designated content to a player device. Content router 150 maintains a data store of sources of content and of information regarding the content provided by the sources, including inter alia (i) media metadata, which may have previously been mapped into a standard namespace using namespace mapper 130, (ii) delivery bit-rate(s) that the content source is capable of providing, (iii) media format(s) or codec(s) that the content source is capable of providing, (iv) media container formats that the content source is capable of providing, (v) DRM types that the content source is capable of providing, and (vi) geographical regions that the content source serves.

When playback of media is requested, content router 150 dynamically evaluates the data in its data store vis-à-vis the playback requirement, and vis-à-vis capabilities of the playback device, and selects the most appropriate source of content for this particular instance.

In an embodiment of the present invention, playback of media is performed from a copy of the content stored locally on the player device. Such local copy may have been stored on the player device by the user independently of the present invention, or may have been cached on the player device during an earlier playback from a source of content identified by counter router 150.

Reference is made to FIG. 10, which is a simplified flowchart for a process of content routing and media playback, as performed by content router 150, in accordance with an embodiment of the present invention. The flowchart of FIG. 10 includes four columns. The leftmost column indicates steps performed by a consumer device, such as a media player; the second-from-left column indicates steps performed by an inventory manager, such as inventory manager 160; the second-from-right column indicates steps performed by a content router, such as content router 150; and the rightmost column indicates steps performed by a content distributor.

At step 1005 the device requests media content for playback. At step 1010 the inventory manager invokes a rights manager, such as rights manager 180, to validate the request. If the rights manager validates the request, then at step 1015 the inventory manager requests the content router to provide a content route for obtaining the requested content. At step 1020 the content router determines an appropriate content distributor, for providing the requested content to the requesting device, based on multiple parameters including inter alia content format, transmission bit-rate, content container, transmission protocol and content digital rights management (DRM).

At step 1025 the content router requests a handle to the requested content from the appropriate distributor as determined at step 1020. At step 1030 the content distributor generates the content handle, and at step 1035 the content distributor returns the content handle to the content router. In turn, at step 1040 the content router forwards the content handle to the inventory manager and, at step 1045, the inventory manager provides the content handle to the device.

At step 1050 the device uses the content handle to request content from the content distributor. At step 1055 the content distributor delivers the content to the device. Finally, at step 1060 the device receives the content, originally requested at step 1005, from the content distributor, and plays the received content.

Reference is made to FIG. 11, which is a diagram illustrating music and video content routing from a multitude of content providers to a multitude of player devices, in accordance with an embodiment of the present invention. As shown in FIG. 11, different player devices may require different content formats, and may require different digital rights management technologies.

### Inventory Manager 160

Shown in FIG. 1 is an inventory manager 160, which maintains information regarding consumers' media inventories, including inter alia music, videos, playlists, podcasts and content subscriptions. Inventory manager 160 is generally implemented on a server computer. In an embodiment of the present invention, consumer inventory may have been previously generated by content scanner 110, content identifier 120 and registrar 140. Inventory manager 160 provides a consumer's inventory to the consumer's player devices, when requested by the consumer.

Reference is made to FIG. 12, which is a simplified flowchart of a process of registering a consumer's inventory, retrieval and display of inventory on a player device, and playback of media on a player device, as performed by inventory manager 160, in accordance with an embodiment of the present invention. The flowchart of FIG. 12 is divided into five columns. The leftmost column indicates steps performed by an exemplary consumer device such as a cell phone; the second-from-left column indicates steps performed by a content scanner, such as content scanner 110; the middle column indicates steps performed by a content identifier, such as content identifier 120; the second-from-right column indicates steps performed by a registrar, such as registrar 140; and the rightmost column indicates steps performed by an inventory manager, such as inventory manager 160.

At steps 1205 and 1210 the cell phone is registered with the registrar, as described hereinabove with reference to FIG. 6. At step 1215 the content scanner scans the consumer's PC for media content. At step 1220 the content identifier identifies the scanned media content. At step 1225 the registrar registers the identified scanned media content to the consumer, and a record identifying the content as being registered to the consumer is created in an inventory data store.

At step 1230 the cell phone requests from the inventory manager an inventory summary of media registered to the consumer. At step 1235 the inventory manager invokes a rights manager, such as rights manager 180, to validate the consumer's account. If the rights manager validates the consumer's account, then at step 1240 the inventory manager retrieves the consumer's inventory summary information from the data store. At step 1245 the inventory manager returns the user's inventory summary information to the cell phone.

At step 1250 the cell phone displays the inventory summary information to the consumer. At step 1255 the consumer selects media to be played, from the media listed in the inventory summary information. At step 1260 the inventory manager invokes the rights manager to validate the consumer's rights to the selected media. If the rights manager validates the media, then at step 1265 the inventory manager invokes the content router to provide the media to the player device, as described hereinabove with reference to FIG. 10. Finally, at step 1270 the cell phone plays the media that was requested at step 1255.

Consumer media inventory may be cached on a player device, obviating the need for inventory manager 160 to provide it at every instance. When the inventory is cached on a player device, inventory manager 160 maintains versioning information regarding the cached inventory and the current state of the consumer's inventory. This allows inventory manager to provide an updated view of the consumer's inventory to the player device so that the player device can update its cached inventory.

### Content Tracker 170

Shown in FIG. 1 is a content tracker 170, which tracks acquisition and playing of content by a consumer. Content tracker 170 is generally implemented on a server computer.

Content tracker 170 maintains, in a data store, an acquisition log that tracks content acquisition events for consumers. Data stored in the acquisition log includes inter alia the identity of the consumer, the identity of the content, the identity of the content store or other service which provided the content, and the data and time of the acquisition.

Additionally, content tracker 170 maintains, in the data store, a playback log that tracks content playback events for consumers. Data stored in the playback log includes inter alia the identity of the consumer, the identity of the content, the identity of the device on which the content was played, the length of time the content was played, and the date and time of the playback.

In accordance with an embodiment of the present invention, content tracker 170 tracks sharing of content and tracks when a shared content item is subsequently purchased.

A consumer may request from system 100 that a content item registered to him be shared with another consumer. Registrar 140 registers the content to the recipient and indicates that the recipient has a trial license for the content. Content tracker 170 records the share in its acquisition log.

When the recipient's trial license for the content expires, the recipient may be offered to purchase the content. Such purchase, if effectuated, then causes registrar 140 to register the content as being owned by the recipient, and causes content tracker 170 to record the purchase event, and to associate the share with the subsequent purchase.

Content tracker 170 also associates shares with subsequent purchases in a case where there are multiple shares of a content item culminating in a purchase. For example, if consumer A shares a content item with consumer B, and consumer B shares the same content item with consumer C, and consumer C subsequently purchases the item, then contact tracker 170 associates customer C's purchase with consumer A's original share.

It will be appreciated by those skilled in the art that content tracker 170 facilitates super-distribution of content.

In accordance with an embodiment of the present invention, content tracker 170 tracks when a first piece of content, referred to herein as “associated media”, triggers a user to purchase a second piece of content.

“Associated media” refers to content that contributes to a user's purchase of other content. For example, a user may watch a movie, and decide to purchase a song from the movie, or the entire soundtrack. The song and the soundtrack are “associated with” the movie, and content tracker 170 tracks this association. When a media item, such as the above mentioned song, is played by the user, content tracker 170 maintains in its data store both the media player and the identity of the media, such as the above mentioned movie, which was associated with the played media.

It will thus be appreciated by those skilled in the art that music and video may be associated with movies, TV shows, games, and live events such as concerts and other performances.

Reference is made to FIG. 13, which is a simplified flowchart of a process of tracking consumer acquisition of media, playback of media, and associations between media items, as performed by content tracker 170, in accordance with an embodiment of the present invention. The flowchart of FIG. 13 is divided into five columns. The leftmost column indicates steps performed by third parties; the second-from-left column indicates steps performed by a player device; the middle column indicates steps performed by a registrar, such as registrar 140; the second-from-right column indicates steps performed by an inventory manager, such as inventory manager 160; and the rightmost column indicates steps performed by a content tracker, such as content tracker 170.

At step 1305 the player device requests media content, designated as media item X, for playback, from the inventory manager. At step 1310 the inventory manager invokes a rights manager, such as rights manager 180, to validate the consumer's rights to media item X, and invokes a content router, such as content router 150, to provide the requested media item X to the player device, as described hereinabove with reference to FIG. 10. At step 1315 the inventory manager reports the consumer's playback of media item X to the content tracker. At step 1320 the content tracker logs the playback of media item X in a tracking log.

The consumer then purchase a song, designated as song Y and related to media item X, from a media retailer. At step 1325 the media retailer reports consumer and media data for the retail media sale of song Y, to the registrar. At step 1330 the registrar invokes namespace mapper 130 to map the consumer and the media information, as described hereinabove with reference to FIGS. 3 and 5. At step 1335 the registrar registers song Y as being owned by the consumer, as described hereinabove with reference to FIG. 6.

At step 1340 the registrar reports the consumer's purchase of song Y to the content tracker. At step 1345 the content tracker logs acquisition of song Y in the tracking log. At step 1350 the registrar invokes the namespace mapper to detect a relationship between song Y and media item X, which was provided to the consumer at step 1310. At step 1355 the registrar reports the related media to the content tracker. At step 1360 the content tracker logs the association between song Y and media item X.

At step 1365 the player device requests playback of song Y, from the inventory manager. At step 1370 the inventory manager invokes the rights manager to validate the consumer's rights to the requested song, and invokes the content router to provide the requested song Y to the player device, as described hereinabove with reference to FIG. 10. At step 1375 the inventory manager reports playback of song Y to the content tracker. At step 1380 the content tracker logs the playback of song Y, and the association of song Y with media item X.

Reference is made to FIG. 14, which is a simplified flowchart of a process of associating items of media with one another, as performed by content tracker 170, in accordance with an embodiment of the present invention. The flowchart of FIG. 14 is divided into five columns. The leftmost column indicates steps performed by a player device; the second-from-left column indicates steps performed by a namespace mapper, such as namespace mapper 130; the middle column indicates steps performed by a media retailer; the second-from-right column indicates steps performed by a registrar, such as registrar 140; and the rightmost column indicates steps performed by a content tracker, such as content tracker 170.

At step 1405 a consumer plays a movie on his set top box. At step 1410 the set top box requests associated media from the namespace mapper. At step 1410 the namespace mapper finds media associated with the movie, including inter alia songs from the movie and games relating to the movie characters. The namespace mapper may identify associated media based on various types of data, including inter alia (i) information, provided by cable providers and by electronic programming guide providers, identifying music associated with scheduled programs, (ii) information provided in data streamed from cable providers or other content providers, and (iii) information provided by game developers identifying media in or associated with a game.

At step 1420 the namespace mapper returns to the player device a list of the associated media found at step 1415. At step 1425 the set top box presents the consumer with opportunities to purchase the associated media. At step 1430 the consumer proceeds to purchase a song, included in the associated media, from a media retailer.

At step 1435 the media retailer executes the purchase and delivers the purchased song to the consumer. At step 1440 the media retailer sends the purchase information to the registrar. At step 1445 the registrar registers the song as being owned by the consumer, as described hereinabove with reference to FIG. 6. At step 1450 the content tracker logs acquisition of the song.

At step 1455 the registrar requests from the namespace mapper media associated with the purchased song. At step 1460 the namespace mapper returns to the registrar a list of media associated with the purchased song, including the original movie played by the consumer at step 1405. At step 1465 the registrar reports the original movie as being associated with the purchase song. At step 1470 the content tracker logs the association between the purchased song and the original movie. In turn, disbursement manager 190 allocates a portion of the revenue generated by the user's purchase of the song to rights holders for the original movie, such as studios, directors, writers and distributors of the original movie.

Generally, registrar 140 recognizes when associated content triggers purchase of new content by:
receiving information from a player device regarding content the user is playing, or has recently played, prior to purchasing his new content;
receiving information from ticketing agencies regarding movie tickets, or tickets for other such events, that the user purchased, where attendance at the movie or other event was temporally or spatially proximate to the purchase of the content;
receiving information from retail stores regarding content the user has purchased, prior to purchasing his new content; and
receiving location-based information, from the user's cell-phone or GPS device, regarding where the user was located prior to purchasing his new content, where such location may have been a theater or other entertainment venue.

The present invention has application to usage tracking for purposes of revenue sharing or for purposes of logging usage history. The present invention is advantageous for tracking the following information for content:
(a) if recorded, when it was recorded and from which provider;
(b) if purchased directly, the fulfiller of the purchase;
(c) if purchased, other content, if any, that is associated with the purchased content and may have contributed to the consumer's decision to make the purchase;
(d) if shared, the consumer who originally owned the copy, the original fulfiller, and the sharing chain of users;
(e) play information for the current owner, whether played on the owner's recorder device or on the owner's player device or on other devices; and
(f) if upgraded from a trial version, the fulfiller of the original purchase by the original owner and the fulfiller of the purchase from the trial version.

### Rights Manager 180

Shown in FIG. 1 is a rights manager 180, which enforces digital rights management. Rights manager 180 is generally implemented on a server computer.

Rights manager 180 maintains a data store of consumer accounts. When a consumer attempts to access system 100, rights manager 180 consults the data store to validate whether or not the consumer's account has the right to access the system, and grants or denies access accordingly.

Additionally, rights manager 180 utilizes a data store of consumers' rights to access given content items.

Rights manager 180 may grant full access for a consumer to a given content item, may deny access, and may provide limited access. Limited access includes inter alia the right to access content for a specific time period, during a specific date range, for a limited number of plays, or in specific geographical locations. Limited access may be used to support trial content.

When a user requests to play a designated piece of content on a designated player device, the request is transmitted to rights manager 180, which confirms that the user has a currently valid license to the requested content. If the user does not have a currently valid license to the requested content, the play request is denied. In one embodiment of the present invention, if the user had a limited license for the requested content which is no longer valid, system 100 enables the user to purchase a valid license.

Rights manager 180 may obtain information regarding a consumer's rights to a designated item of content from content scanner 110, whereby content scanner 110 finds content on a user's PC that is wrapped in a DRM wrapper, parses the DRM wrapper to determine the usage rules governing the content, and transmits the usage rules to registrar 140. Registrar 140 in turn stores the rules in a data store where they are enforced by rights manager 180.

Rights manager 180 may also obtain information regarding a consumer's rights to a designated item of content from a third party such as inter alia a media store or a media subscription service. When a consumer purchases content or a content subscription from a store, the store may transmit to registrar 140 information about the consumer, the purchase, and the usage rules applicable to the designated user and the designated content. Registrar 140 stores the results in a data store where they are enforced by rights manager 180.

Reference is made to FIG. 15, which is a simplified flowchart of a process of validating and enforcing consumer rights to media, as performed by rights manager 180, in accordance with an embodiment of the present invention. The flowchart of FIG. 15 is divided into three columns. The left column indicates steps performed by a consumer's player device; the middle column indicates steps performed by an inventory manager, such as inventory manger 160; and the right column indicates steps performed by a rights manager, such as rights manager 180.

At step 1505 the player device requests a summary of its inventory from the inventory manager. At step 1510 the inventory manager requests the rights manager to validate the consumer's account. At step 1515 the rights manager validates the status of the consumer's account by consulting a consumer account data store. If the consumer's account is valid, then at step 1520 the rights manager returns an account authorization to the inventory manager. At step 1525 the inventory manager retrieves the consumer's inventory information, as described hereinabove with reference to FIG. 12, and sends it to the player device.

At step 1530 the player device displays to the consumer his summary inventory information. At step 1535 the player device requests, from the inventory manager, media from the inventory for playback. At step 1540 the inventory manager requests the rights manager to validate the consumer's rights to the requested media. At step 1545 the rights manager validates the consumer's rights by consulting a media inventory and rights data store. If the rights manager validates the consumer's rights to the requested media, then at step 1550 the rights manager returns a media authorization to the inventory manager. At step 1555 the inventory manager requests a route to the media from content router 150, as described hereinabove with reference to FIG. 10.

### Disbursement Manager 190

Shown in FIG. 1 is a disbursement manager 190, which allocates revenue to various vendors in the content purchase and supply chains. Disbursement manager 190 is generally implemented on a server computer. Reference is made to FIG. 16, which is a simplified block diagram of a revenue disbursement system 1600, in accordance with an embodiment of the present invention. Shown in FIG. 16 is a data manager 1610, which manages four data stores. The first data store, 1620, stores records of content, content owners, and content providers. The second data store, 1630, stores records of users and their acquired content. The third data store, 1640, stores a content usage history log according to user and time period. The fourth data store, 1645, stores records of revenues generated from various sources, including inter alia (i) from media purchase, (ii) from media subscriptions, (iii) from media access services, and (iv) from advertising. The data in data stores 1620, 1630, 1640 and 1645 is inter-related by reference links such as foreign keys.

Also shown in FIG. 16 is a user content browser 1650, such as a player device, which enables a user to interactively browse, organize and access his content and his playlists.

Also shown in FIG. 16 is a rights manager 1660, such as rights manager 180. If rights manager 1660 verifies that the user has a currently valid license to the requested content, then a content provisioner 1670, such as content router 150, identifies one or more sources that can supply the requested content to the user in a format compatible with the user's player device.

A tracking server 1680, such as content tracker 170, records a history log regarding the user's playing of content, and a disbursement manager 1690, such as disbursement manager 190, uses the history log to disburse subscription revenue received from the user to content owners and content provisioners, and other stakeholders in the purchase and delivery chains.

It will be appreciated by those skilled in the art that embodiments of the present invention enable revenue disbursement among various partners in content purchase and supply chains, including inter alia (i) content owners, (ii) service providers, (iii) content distributors, (iv) registrants, (v) enablers, and (vi) other vendors that enable operation of embodiments of the present invention.

Content owners are entities that hold intellectual property rights to content. These rights include inter alia publishing rights, rights to sound recordings, rights to video recordings and distribution rights. Content owners may be inter alia music labels, music publishers, collecting societies, movie studios and movie production companies.

Service providers are often mobile operators. Service providers generally maintain customer relationships, and are responsible for billing and collection. Mobile operator service providers also provide delivery of content over their wireless networks to cellular devices.

Content distributors are generally responsible for aggregating acquired content and delivering the content to consumers' player devices. Delivery is via download or streaming, either over the Internet or over a mobile operator's communication channels. Content managers may also maintain advertising media for ad-supported content or services. In some instances, a mobile operator may provide its own content, in which case the mobile operator serves as both an operator and a content manager. In other instances, content may reside with a plurality of content managers. Embodiments of the present invention support integration and revenue disbursement in all instances.

Registrants are generally responsible for registering consumer ownership of media with registrar 140. Registrants may be inter alia developers of content scanner 110, and media retail stores. Regarding developers of content scanner 110, when content scanner 110 runs on a consumer's PC and sends information about the media on the PC to content identifier 120, registrar 140 maintains a record indicating that the developer of content scanner 110 is the registrant for the subject media and for the subject consumer. Regarding media retail stores, when a store sells a media item to a consumer, the store notifies registrar 140 of the sale, and registrar 140 maintains a record indicating that the media retailer is the registrant for the subject media and for the subject customer. In both cases, disbursement manager 190 utilizes this information for allocating revenue to appropriate members of the content supply chain.

Enablers are generally responsible for causing a device or software application to be compatible with an embodiment of the present invention. Enablers include inter alia (i) manufacturers of mobile handsets who provide built-in capability to utilize an embodiment of the present invention with the handset, (ii) independent developers of software for mobile handsets who provide such capability, and (iii) manufacturers of player devices or recorder devices, or developers of software for player devices or recorder devices who provide such capability.

Other vendors that enable operation of embodiments of the present invention are generally responsible inter alia for maintaining lists of consumers' content, for controlling access to consumers' content based on rights management and criteria such as consumer subscription levels, for providing technology enabling identification of consumers' content, and for tracking content distribution and consumer usage. In some instances, the other vendors that enable operation of embodiments of the present invention may also handle customer relationships, customer billing and collection, and serve as clearinghouses. Again, embodiments of the present invention support integration and revenue disbursement in all instances.

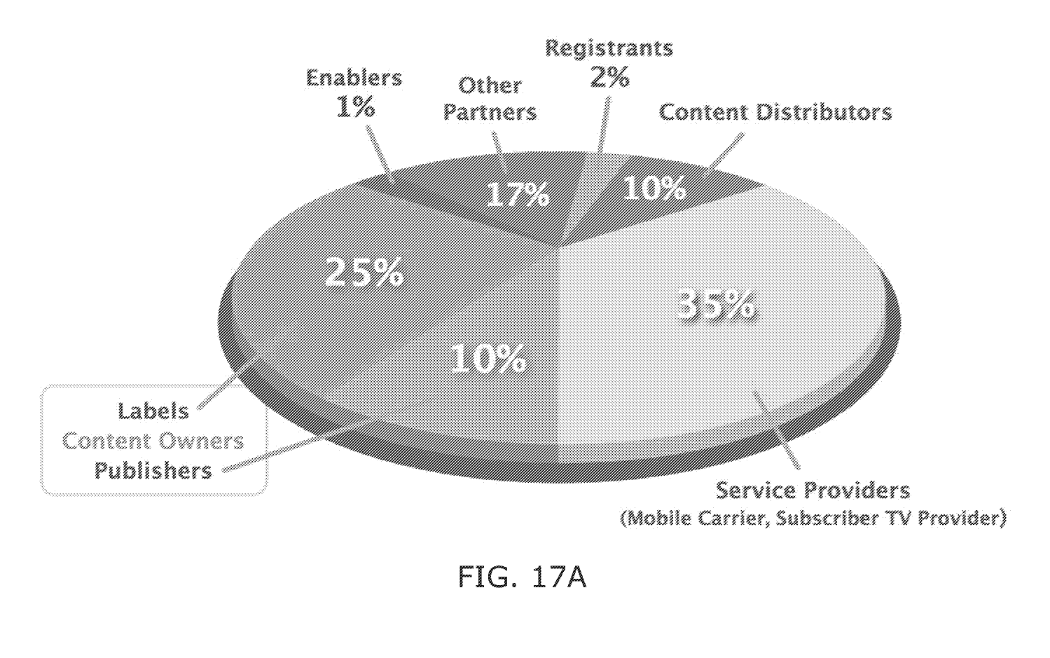

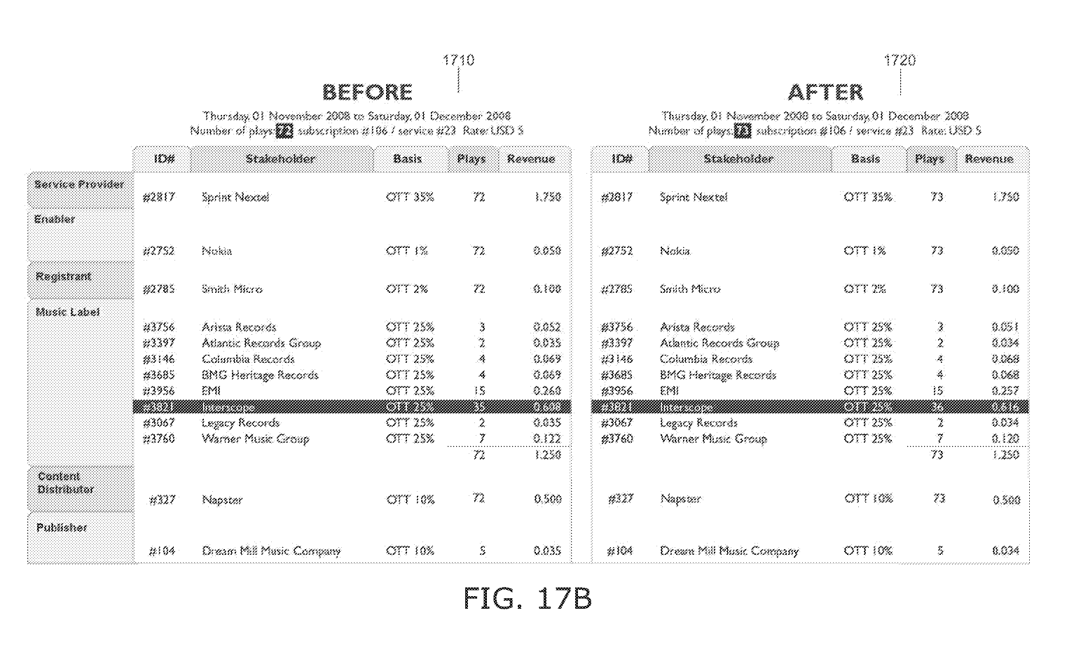

Reference is made to FIG. 17A, which is a diagram illustrating subscription revenue disbursement between content owners, content distributors, service providers, registrants, enablers and other partners, in accordance with an embodiment of the present invention. Shown in FIG. 17A is a revenue sharing formula that allocates 25% of a consumer's subscription revenue to music labels, 10% to music publishers, 35% to service providers, 2% to registrants, 10% to content distributors, 1% to enablers, and 17% to other partners.

Reference is made to FIG. 17B, which is an illustration of an accounting report for distributing the percentages allocated in FIG. 17A to the content owners, among a plurality of content owners, in accordance with an embodiment of the present invention. Shown in the accounting report are revenue portions for service providers (35% off the top), enablers (1% off the top), registrants (2% off the top), music labels (25% off the top), content distributors (10% off the top), and publishers (10% off the top), based on a subscription fee of $5. The 25% allocated to music labels is further distributed along eight labels; namely, Arista Records, Atlantic Records Group, Columbia Records, BMG Heritage Records, EMI, Interscope Records, Legacy Recordings and Warner Music Group. The inter-label distribution of revenue is based on the relative number of pieces of content played by the consumer from each label. Thus, as indicated in accounting report 1710, of 72 pieces of content played by the consumer during the time period Nov. 1, 2007-Dec. 1, 2007, 35 pieces are from the Interscope label. Accordingly, Interscope is allocated 35/72 of the 25% revenue; i.e., 35/72 of $1.25, which is $0.608.

If the consumer plays an addition piece of content from the Interscope label, then report 1710 is dynamically modified to report 1720, wherein the allocation to Interscope is dynamically adjusted upwards to 36/73 of the 25% revenue, which is $0.616. Similarly, the allocations of the 25% to the other labels are adjusted downwards, as indicated in report 1720.

It will be appreciated by those skilled in the art that tracking server 1680 generally determines relative frequencies f₁, f₂, . . . , fₙ with which a consumer uses content owned by label number k, during a specified time period, relative to the consumer's total usage of content, for each of n content labels k=1, 2, . . . , n. Revenue to the n content labels for the specified time period is then allocated based on the relative frequencies. In one embodiment of the present invention, fₖ is the number of pieces of content owned by label k and played by the consumer during the specified time period, relative to the total number of pieces of content played by the consumer during the specified time period. E.g., the relative frequencies indicated in report 1720 for the eight content labels are 3/73, 2/73, 4/73, 4/73, 15/73, 36/73, 2/73 and 7/73. These relative frequencies are the multipliers for allocating $1.25 of the subscription revenue earmarked for the labels, among the eight labels.

In another embodiment of the present invention, fₖ is the time spent by the consumer playing content owned by label k during the specified time period, relative to the total time spent by the consumer playing content during the specified time period.

In another embodiment of the present invention, fₖ is the number of the consumer's content items attributed to label k at the time of report generation, relative to the consumer's total inventory of content. This allocation may be applicable when there were no play events during a particular reporting period.

It will be appreciated by those skilled in the art that use of tracking server 1680 supports a wide variety of revenue allocation models including inter alia
sliding scale percentages, such as
   percentages that scale with volume,
   percentages that scale with content plays, and
   percentages that scale with numbers of registered users;
pre-established minimum amounts;
pro-rata splits;
off-the-top allocations; and
breakdown of leftover revenues, such as
   across the board breakdown,
   breakdown pro-rated by actual revenue breakdown for the period, and
   breakdown across members of a particular group.

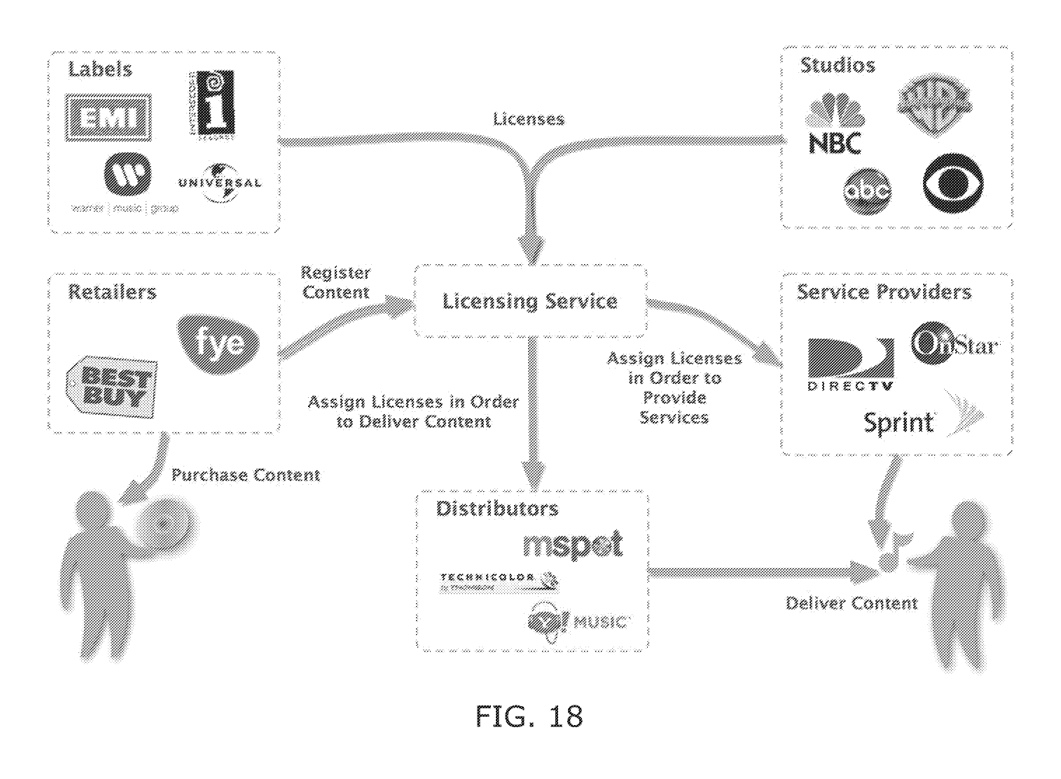

Reference is made to FIG. 18, which is a summary diagram of vendors in the content purchase and supply chain, integrated within a content licensing service, in accordance with an embodiment of the present invention. Shown in FIG. 18 are content labels, content studios, content distributors, content retailers and service providers, all integrated within a content licensing service. Each of the vendors shown in FIG. 18 is eligible to receive a portion of consumer subscription revenue.

In accordance with an embodiment of the present invention, disbursement manager 190 allocates portions of revenue generated from a piece of content to rights holders for media “associated” with the purchased content, as defined hereinabove with reference to content tracker 170. Thus if a user watches a movie, and decides to purchase a song from the movie, or the entire soundtrack, then disbursement manager 190 allocates a portion of revenue from the song or the soundtrack to rights holders of the movie. Furthermore, when the user subsequently plays the song or soundtrack, disbursement manager 190 allocates a portion of the revenues associated with the playing of the song or soundtrack to the rights holders of the movie.

It is noted that when a user purchases content, disbursement manager 190 only allocates revenue to associated content rights holders in situations where the associated content is a trigger for purchase of the purchased content, as described hereinabove with reference to content tracker 170. In situations where the associated content is not such a trigger, then the revenue is not shared among the associated content rights holders.

### Use Cases

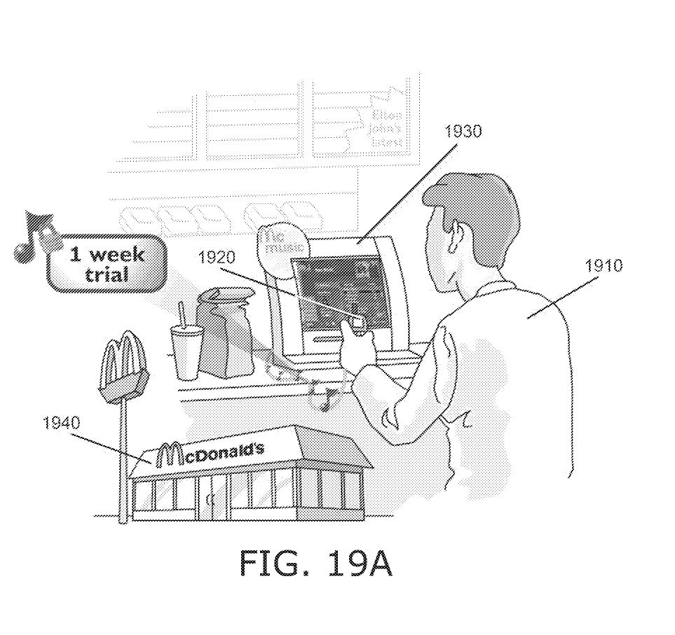

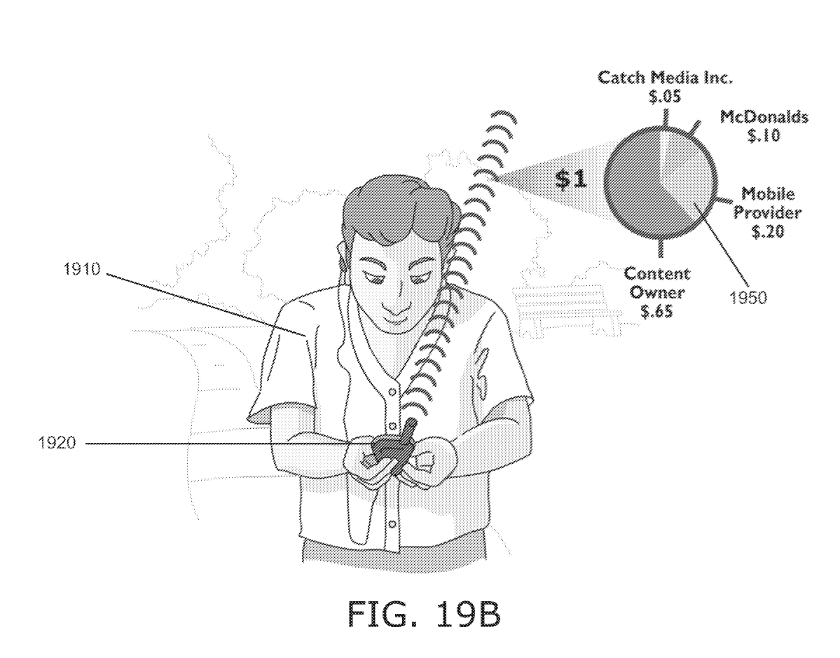

Reference is made to FIGS. 19A and 19B, which are simplified illustrations of a consumer use case of acquiring content in accordance with an embodiment of the present invention. As shown in FIG. 19A, a consumer 1910 downloads a trial version of content onto his player device 1920 from a McMusic kiosk 1930 located within a McDonald's store 1940. Consumer 1910 has limited rights to play the content for a one-week trial period. Subsequently, as shown in FIG. 19B, consumer 1910 decides to purchase the content for $1.00 from a store via wireless communication. As a result of the purchase, consumer 1910 is granted full rights to the song.

Also shown in FIG. 19B is a pie chart 1950 illustrating how the $1.00 of revenue for the content is allocated between the content owner, the wireless provider, McDonald's and the owner of the present invention.

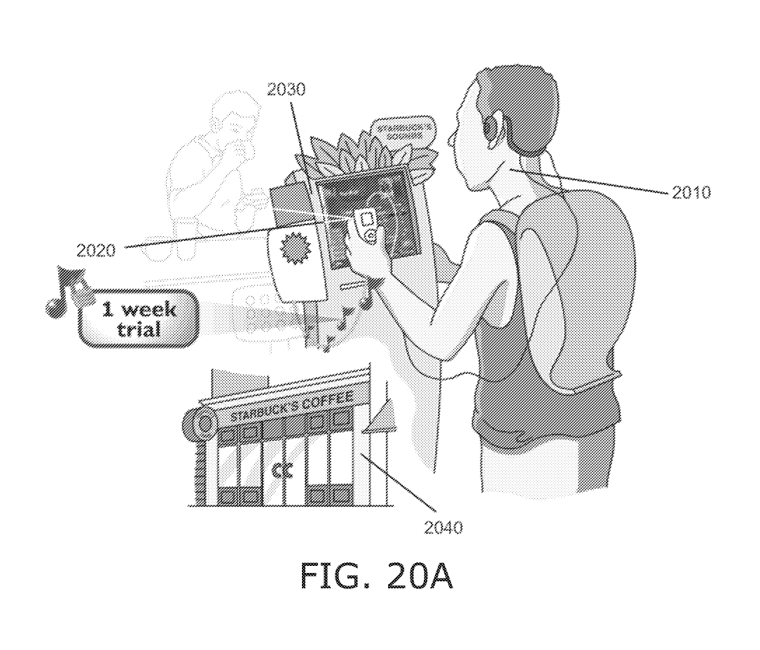

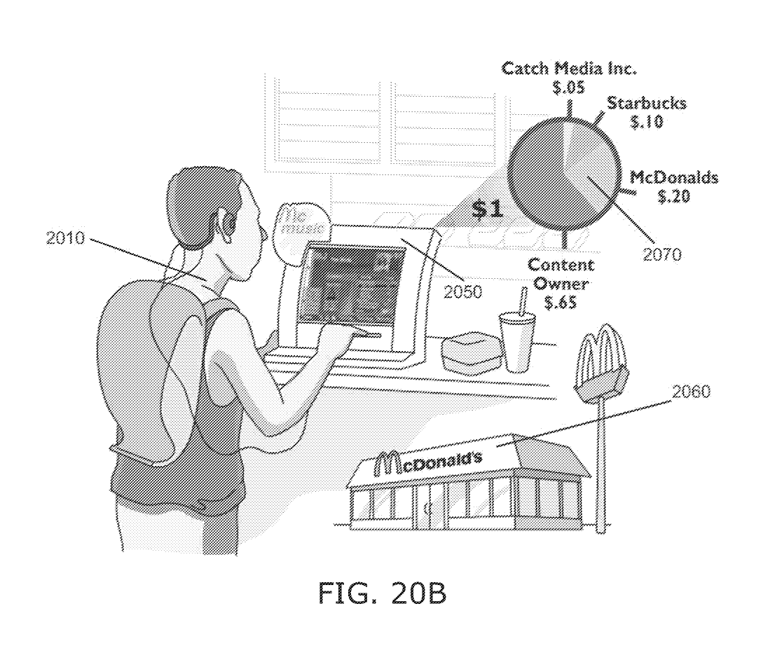

Reference is made to FIGS. 20A and 20B, which are simplified illustrations of a second consumer use case of acquiring content in accordance with an embodiment of the present invention. As shown in FIG. 20A, a consumer downloads a trial version of content onto his player device 2020 from a Starbuck's Sounds kiosk 2030 located within a Starbuck's store 2040. Consumer 2010 has limited rights to play the content for a one-week trial period. Subsequently, as shown in FIG. 20B, consumer 2010 decides to purchase the content for $1.00 from a McMusic kiosk 2050 located within a McDonald's store 2060. As a result of the purchase, consumer 2010 is granted full rights to the content.

Also shown in FIG. 20B is a pie chart 2070 illustrating how the $1.00 of revenue for the content is allocated between the content owner, Starbuck's, McDonald's and the owner of the present invention.

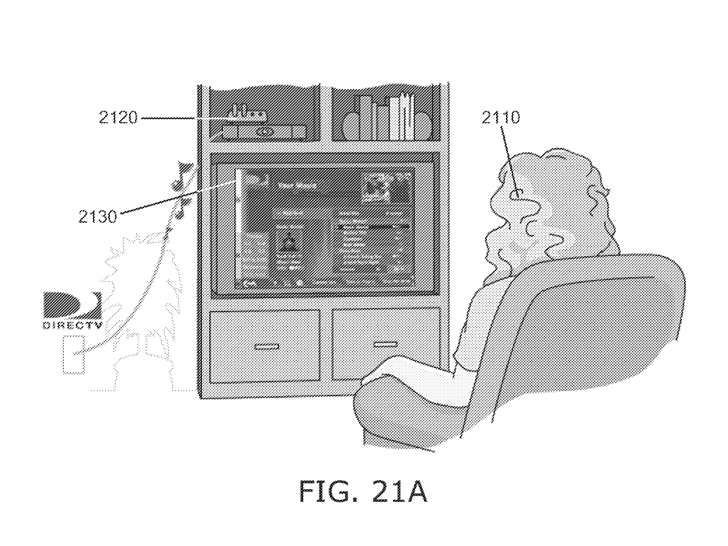

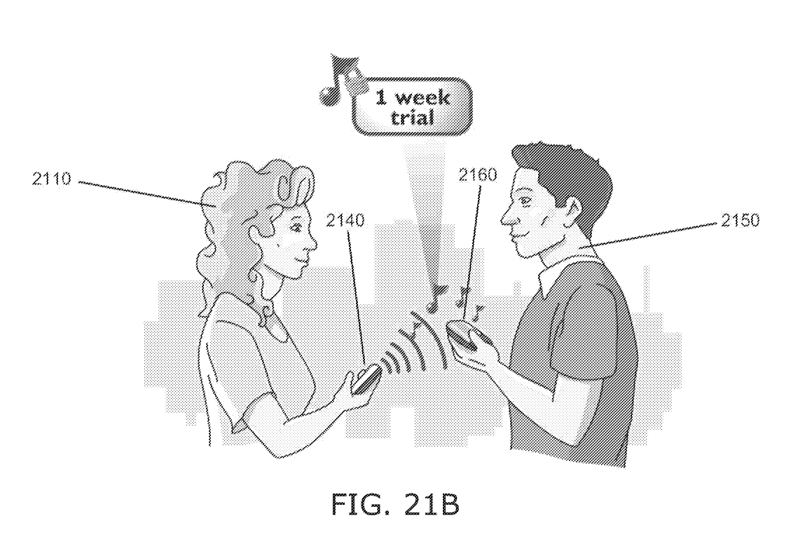

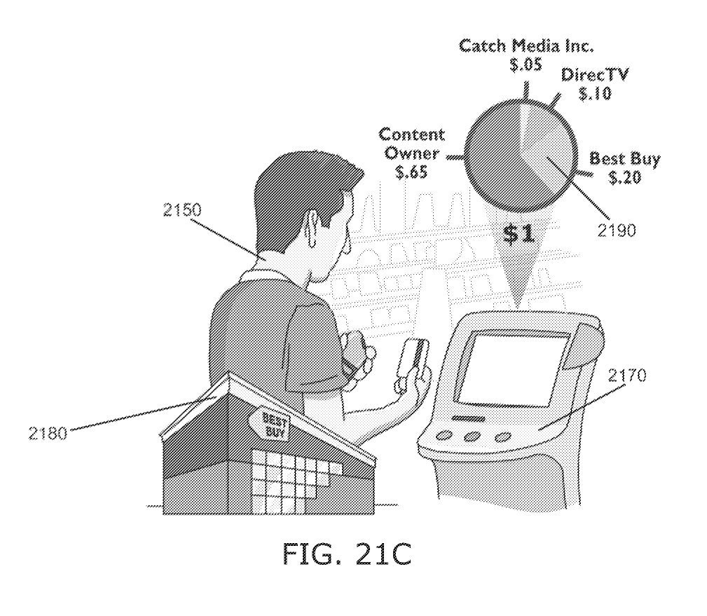

Reference is made to FIGS. 21A, 21B and 21C, which are simplified illustrations of a third consumer use case of acquiring content in accordance with an embodiment of the present invention. As shown in FIG. 21A, a consumer 2110 records content from a DirectTV broadcast media station onto her recorder device 2120, while enjoying home entertainment on her television 2130. Consumer 2110 copies the content from her recorder device 2120 onto her player device 2140.

Subsequently, as shown in FIG. 21B, consumer 2110 meets a friend, namely consumer 2150, who expresses interest in the content. Consumer 2110 instructs the player software to share the content with consumer 2150. The player software sends a message to the tracking server indicating that the content should be shared with consumer 2150. The tracking server uses rights manager 180 to validate that the content may be shared and, if so, updates the inventory of consumer 2150 to include the shared content. The shared content is generally provided to consumer 2150 with a trial license, whereby consumer 2150 only has limited rights to play the content for, for example, a one week trial period.

Subsequently, as shown in FIG. 21C, consumer 2150 decides to purchase the content, which he does for $1.00 via a media kiosk 2170 located in a Best Buy store 2180. After purchasing the content, consumer 2150 is granted full rights to the content.

Also shown in FIG. 21C is a pie chart 2190, indicating allocation of the $1.00 purchase price for the content between the content owner, DirectTV, Best Buy and the owner of the present invention.

### System Architecture

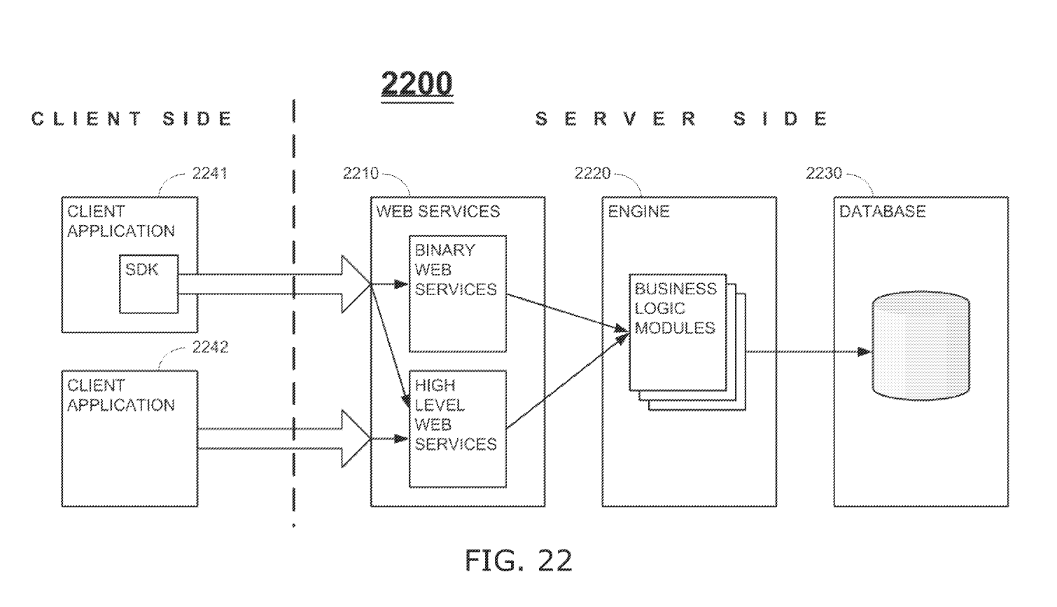

Reference is made to FIG. 22, which is a simplified high-level architecture diagram of a content provisioning and revenue disbursement system 2200, in accordance with an embodiment of the present invention. System 2200 is divided into client side components, shown on the left, and server side components, shown on the right The server-side components include a web services layer 2210, an engine layer 2220, and a database layer 2230. The client-side components include client applications 2241 and 2242.

Client application 2241 communicates with revenue disbursement system 2200 via an SDK, described further hereinbelow. Client application 2242 communicates with web services layer 2210 directly.

Client applications 2241 and 2242 may include inter alia mobile phones, content management applications, set top boxes or other player or recorder devices, as described hereinabove.

Web services layer 2210 handles communication with system 2200. In one embodiment of the present invention, a software development kit (SDK) is provided, in order to abstract the web services communication and other aspects of integration. Engine layer 2220 implements business logic for system 2200, including business logic for modules 120-190 of FIG. 1. Database layer 2230 maintains one or more data stores for system 2200, including the data stores for modules 120-190 of FIG. 1.

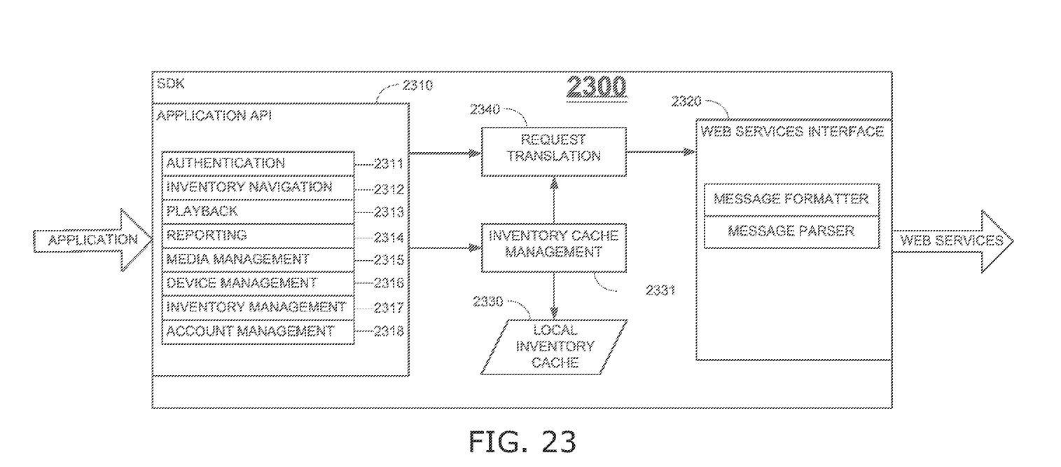

Reference is made to FIG. 23, which is a simplified architecture diagram of an SDK 2300 that is provided with the system 2200, in accordance with an embodiment of the present invention. SDK 2300 includes an application programming interface (API) 2310 which interfaces with applications that integrate the SDK.

API 2310 provides applications with access to features of system 2200, including inter alia authentication 2311, inventory navigation 2312, playback of content 2313, reporting 2314, media management 2315, device management 2316, inventory management 2317 and account management 2318.

SDK 2300 also includes a web services interface 2320, which provides a communication layer between SDK 2300 and the server side of system 2200.

SDK 2300 may include a local cache 2330 of a consumer's inventory, allowing SDK 2300 to provide the consumer with access to his content inventory without requiring communication with server components. Local inventory cache 2330 is accessed via an inventory cache management component 2331. SDK 2300 may also operate without local inventory cache 2330, in which case API 2310 communicates with web services interface 2320 via a translation layer 2340.

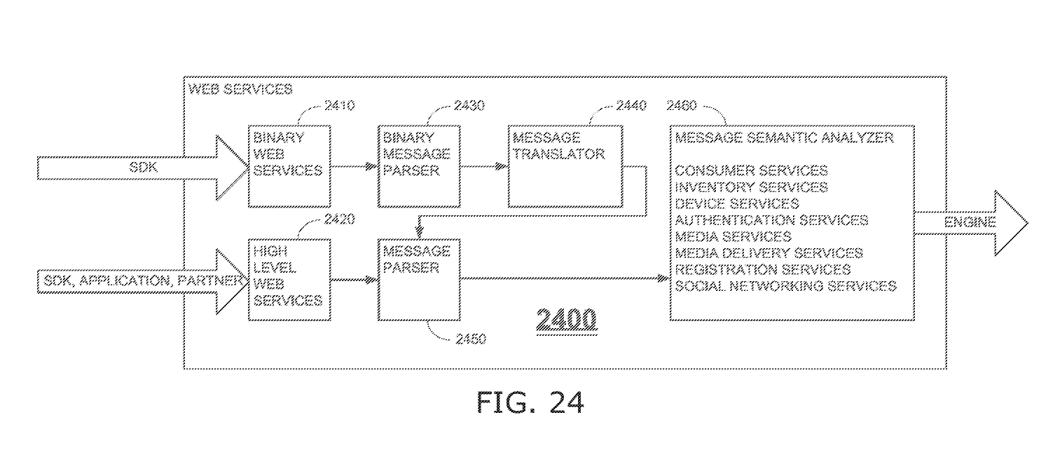

Reference is made to FIG. 24, which is a simplified architecture diagram of a web services layer 2400 of system 2200, in accordance with an embodiment of the present invention. Web services layer 2400 provides two types of services; namely, binary web services 2410 and high level web services 2420.

Binary web services 2410 are provided for low-level client applications and devices, which may be limited in computational capability and/or memory capacity. Such client devices generally provide a lightweight binary interface protocol. Such client devices may include inter alia low-end cellular phones or embedded devices. Binary web services are generally accessed via SDK 2300 and not directly from client applications.

High level web services 2420 provide an interface for more advanced applications and devices, such as PC applications and smartphones. High level web services are generally accessible from client applications, from SDK 2300 and from backend systems of companies working with system 2200, such as content distributors, registrants and other partners.

Messages from binary web services 2410 are parsed by a message parser 2430, and translated into high level web services by a message translator 2440. The translated messages are in turn parsed by message parser 2450, and passed to a semantic analyzer 2460, which determines message validity and provides the messages to engine 2220.

Messages from high level web services 2420 do not require binary message parsing, and are provided directly to message parser 2450 which, in turn, passes them to semantic layer 2460.

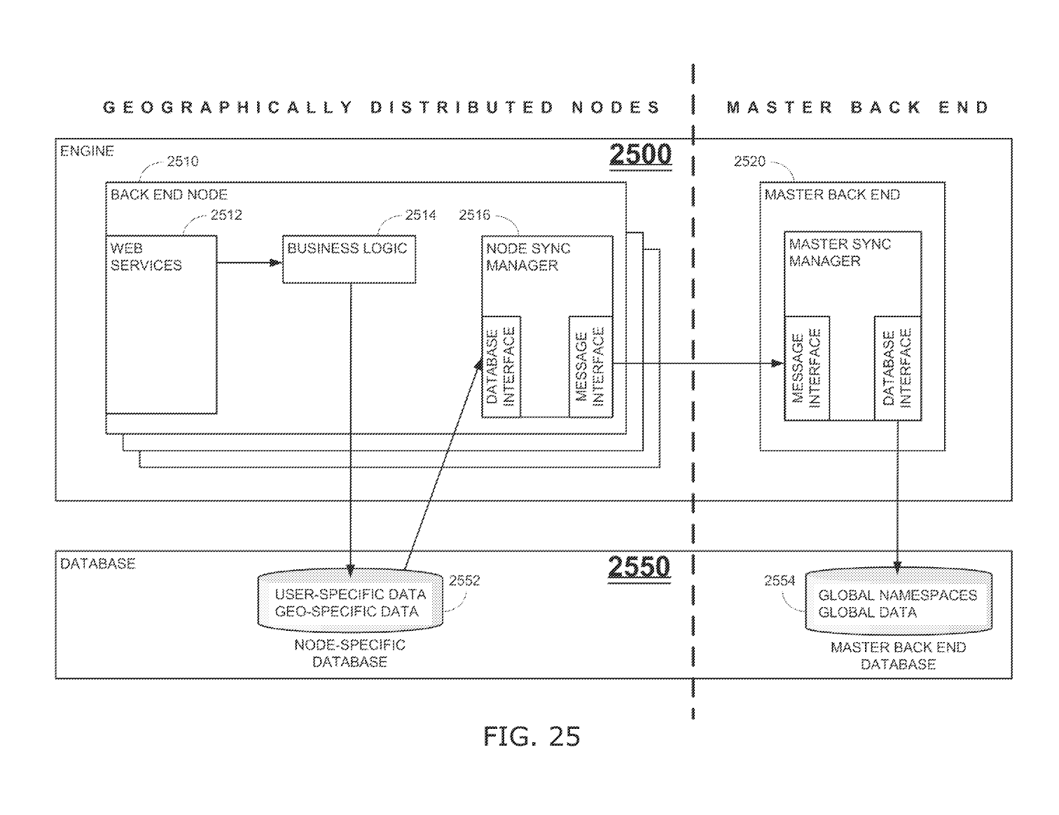

Reference is made to FIG. 25, which is a simplified architecture diagram of an engine layer 2500 and a database layer 2550 of system 2200, in accordance with an embodiment of the present invention.

Engine layer 2500 may contain multiple back end nodes 2510. Each such back end node 2510 services a specific subset of consumers or devices that communicate with system 2200. The allocation of consumers and devices between different back end nodes 2510 may be inter alia geographic or service based.

Database layer 2550 contains a node-specific database 2552 and a master back end database 2554. Each instance of a node-specific database 2552 contains data associated with and maintained by a single instance of a back end node 2510. Such data may include inter alia consumer media data for the consumers serviced by the database's specific back end node 2510.

Master back end database 2554 exists in only one instance for system 2200, and contains data that is common across all back end nodes 2510.

Engine layer 2500 also includes master back end 2520, which serves to synchronize back end nodes 2510 with master back end database 2554.

It will be appreciated by those skilled in the art that the breakdown of engine 2500 into back end nodes 2510 and master back end 2520 is one of several mechanisms that enable system 2200 to achieve massively scalability.

Each instance of a back end node 2510 includes a web services layer 2512, a business logic layer 2514, and a node synchronization manager 2516.

Web services layer 2512 receives communications from web services 2210, Business logic layer 2514 implements core business logic of system 2200.

Node synchronization manager 2516 provides data to master back end 2520. Master back end 2520 propagates data to master back end database 2554, and then to other instances of node specific database 2552.

It will be appreciated by those skilled in the art that segmenting database layer 2550 into non-specific databases 2552 and master back end database 2554, is one of several mechanisms enabling system 2200 to be massively scalable.

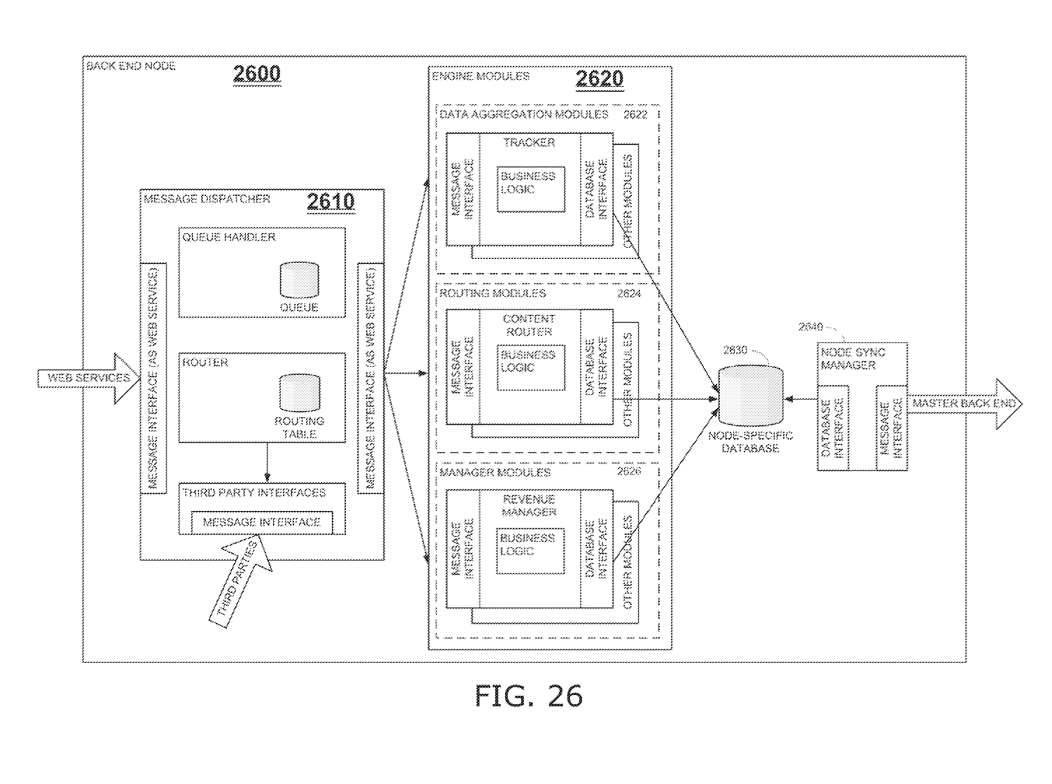

Reference is made to FIG. 26, which is a simplified architecture diagram of a back end node 2600 of system 2200, in accordance with an embodiment of the present invention. Back end node 2600 is an instance of back end node 2510.

Back end node 2600 receives requests from partners and player devices, as described hereinabove. Partners include inter alia owners of media content, and providers of media content. Player devices include inter alia mobile phones, portable media players and automobile decks. Back end note 2600 uses a message dispatcher 2610 to forward messages to a set of engine modules 2620, such modules implementing the core business logic of engine 2500.

Back end node 2600 also contains a node-specific database 2630, corresponding to node-specific database 2552, and a node synchronization manager 2640, corresponding to node synchronization manager 2516.

Message dispatcher 2610 manages incoming requests and routes them to their appropriate destinations. The destinations may be internal to system 2200, such as engine modules 2620, or external to system 2200, such as content owners and content distributors.

Engine modules 2620 implement core functionality of system 2200. An engine module generally exists for each of the server components shown in FIG. 1. Additional modules may exist to provide additional functionality, or to provide support functionality for the components of FIG. 1.

Engine modules 2620 are broken up into data aggregation modules 2622, routing modules 2624 and manager modules 2626. It will be appreciated by those skilled in the art that this breakdown is artificial, and is made herein for the sake of clarity in understanding roles of the different modules. Data aggregation modules 2622 include inter alia content tracker 170. Routing modules 2624 include inter alia content router 150. Manager modules 2626 include inter alia rights manager 180 and disbursement manager 190.

Each engine module 2620 maintains its relevant data store in node-specific database 2630. Node-specific database 2630 is synchronized with master back end database 2554 via node synchronization manager 2640, as described hereinabove.

### Insuring Digital Assets

The present invention is of advantage to appraising and insuring inventories of digital assets. The present invention is of advantage to consumers, who invest substantial money in accumulating personal media collections, by providing them with an accurate registry of their digital assets and the rights they have thereto, and enabling them to insure their collections against loss and theft. The present invention is also of advantage to insurance companies, by enabling them to insure people's valuable media inventories with accurate appraisal value, and to process claims for lost or stolen media items.

Moreover, the present invention also provides insurers with an easy mechanism to replace lost or stolen media collections. Media may be replaced in the same physical or non-physical form that it had prior to loss or theft; i.e., physical CDs are replaced with physical CDs and computer media files are replaced with computer media files.

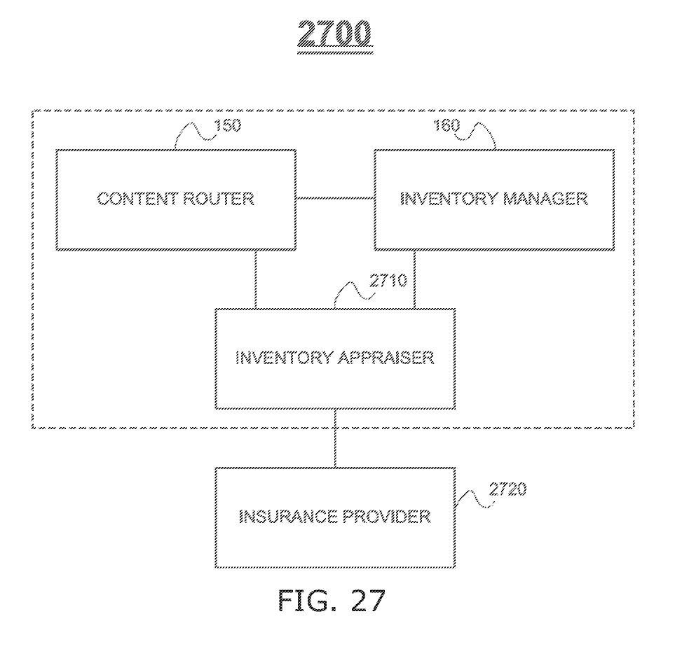

Reference is made to FIG. 27, which is a simplified block diagram of a system for appraising an inventory of digital assets, in accordance with an embodiment of the present invention. Shown in FIG. 27 are two components of system 100, namely, content router 150 and inventory manager 160. As described hereinabove with reference to FIG. 12, inventory manager 160 maintains information regarding a consumer's registered digital asset inventory. In addition, inventory manager 160 has access to the consumer's registered rights to the digital assets in his inventory, via rights manager 180. Content located by content scanner 110 on a consumer's PC and content purchased by the consumer at media retail outlets and music kiosks, and trial content received from friends and other sources, is recorded by inventory manager 160. As described hereinabove with reference to FIG. 10, content router 150 maintains a data store of content sources, and of information regarding the content provided by the sources including inter alia media format.

By combining the information available to content router 150 and inventory manager 160, it is possible to derive an appraisal value for the consumer's inventory of digital assets. For each digital asset in the consumer's inventory, an inventory appraiser 2710 determines the cost of purchasing the consumer's registered rights for the digital asset from an appropriate content source identified by content router 150. Inventory appraiser 2710 accumulates the individual costs to derive an appraisal value for the consumer's entire inventory.

In accordance with an embodiment of the present invention, inventory appraiser 2710 interfaces with an insurance provider system 2720, which uses the appraisal to calculate an insurance premium for insuring the consumer's media content inventory.

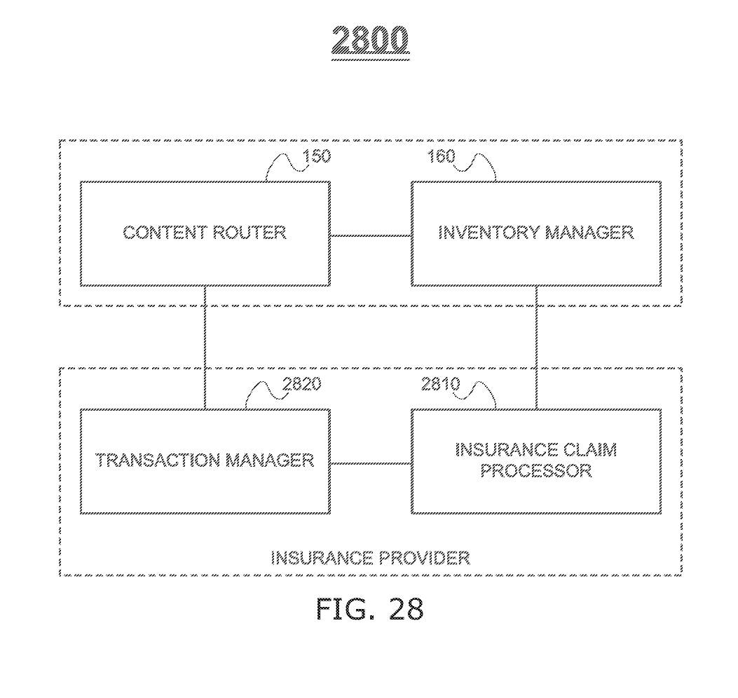

Reference is made to FIG. 28, which is a simplified block diagram of a system for insuring an inventory of digital assets, in accordance with an embodiment of the present invention. In addition to content router 150 and inventory manager 160, shown in FIG. 28 is an insurance claim processor 2810 and a transaction manager 2820. Insurance claim processor 2810 receives a claim from a consumer for one or more digital assets that are lost or stolen. Insurance claim processor 2810 consults with inventory manager 160 to determine the consumer's registered rights to each of the claimed digital assets. Digital assets for which the consumer does not have registered rights are removed from the insurance claim. The remaining digital assets are transmitted to transaction manager 2820 for recovery.

Transaction manager 2820 consults with content router 150 to identify an appropriate content source, for each digital asset in the insurance claim. Transaction manager 2820 proceeds to purchase the registered rights to the digital asset, for recovery to the consumer.

If a digital asset cannot be obtained from a content source, such as a private digital asset, inventory manager 160 saves a copy of the digital asset for recovery purposes.

In accordance with an embodiment of the present invention, inventory claim processor 2810 and transaction manager 2820 are components an insurance provider system, which insures the consumer's media content inventory.

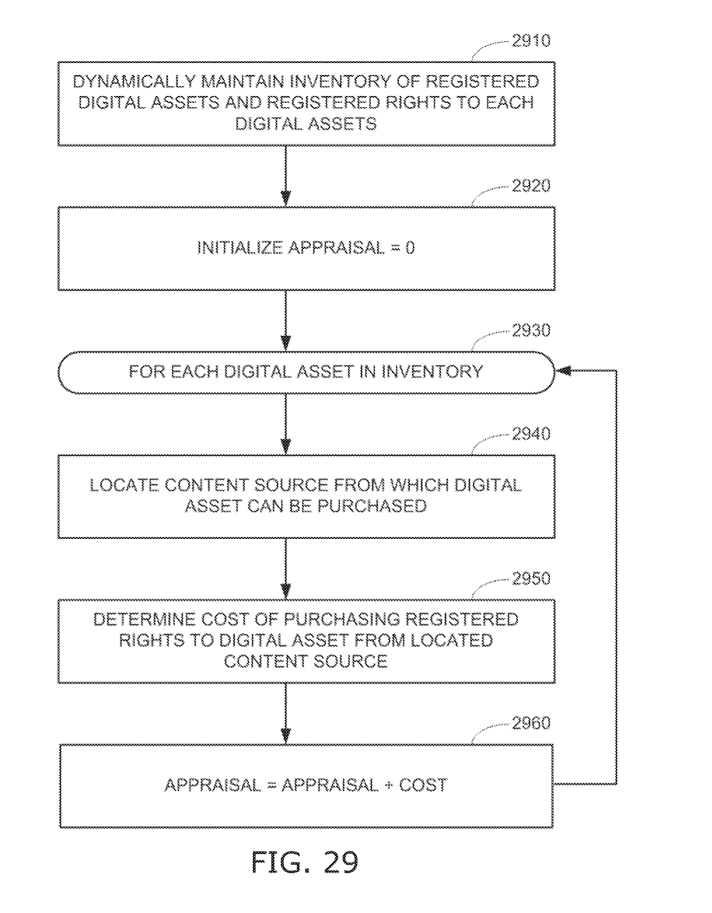

Reference is made to FIG. 29, which is a simplified flowchart of a method for appraising an inventory of digital assets, in accordance with an embodiment of the present invention. At step 2910 an inventory manager dynamically maintains a current inventory of digital assets belonging to a consumer, and the rights that the consumer has to each digital asset. At step 2920 an appraisal value is initialized to zero.

At step 2930 a processing loop processes each digital asset in the consumer's inventory. At step 2940 a content source, from which the digital asset may be purchased, is identified. At step 2950 a cost of purchasing the rights that the customer has to the digital asset, from the content source identified at step 2940, is determined. At step 2960 the cost determined at step 2950 is added to the appraisal value, which thus accumulates the total cost for replacing the entire inventory.

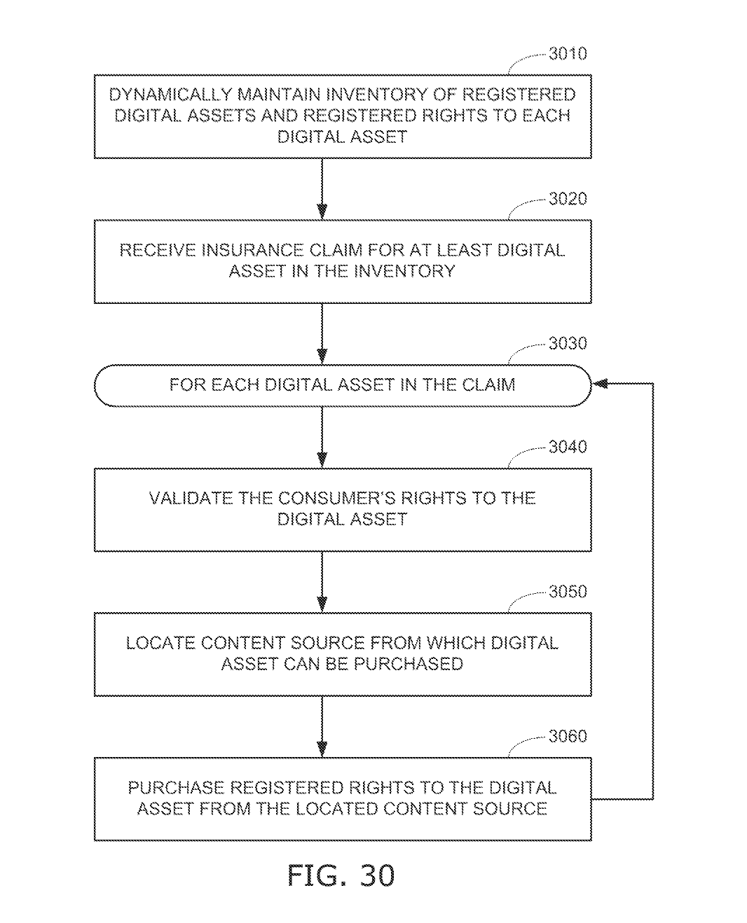

Reference is made to FIG. 30, which is a simplified flowchart of a method for insuring an inventory of digital assets, in accordance with an embodiment of the present invention. At step 3010 an inventory manager dynamically maintains a current inventory of digital assets belonging to a consumer, and the rights that the consumer has to each digital asset. At step 3020 an insurance claim is received for one or more digital assets from the consumer's inventory. The insurance claim may relate to the entire inventory, in case of loss or theft thereof, or to a portion of the entire inventory.

At step 3030 a processing loop processes each digital asset in the insurance claim. At step 3040 the rights that the consumer has to the digital asset are validated, to ensure that the consumer has currently valid rights thereto. At step 3050 a content source, from which the digital asset may be purchased, is identified. If a digital asset cannot be obtained from a content source, such as a private digital asset, a copy of the digital asset is saved for recovery purposes.

At step 3060 the digital asset is purchased from the content source identified at step 3050, and the digital asset in the consumer's inventory that was lost or stolen is replaced with the newly purchased item.

In some embodiments of the present invention, the loop over steps 3040-3060 is performed in two separate loops. A first loop, performed by an insurance claim processor, such as insurance claim processor 2810 of FIG. 28, validates digital assets in the insurance claim at step 3040, and prepares a list of validated claimed digital assets. A second loop, performed by a transaction manager, such as transaction manager 2820 of FIG. 28, identifies a content source for each validated digital asset at step 3050, and purchases the consumer's registered rights to the digital asset at step 3060.

It will be appreciated by those skilled in the art that the systems and methods of FIGS. 27-30 are applicable to consumers that own media collections, whether or not the consumers are subscribers to the content provisioning and revenue disbursement system 100 of FIG. 1. I.e., consumers who do not benefit from the content provisioning may nevertheless benefit from the appraisal and insurance features that are enabled by components of system 100. Consumers who simply purchase their digital assets at media retail stores, without use of a PC, may use the present invention to insure their media collections, and insurance companies may use the present invention to provide such insurance coverage.

It will also be appreciated by those skilled in the art that the systems and methods of FIGS. 27-30 are applicable to media archives owned by museums or other such entities that collect media.

### E-Used Digital Media

The present invention is of advantage in re-sale of digital assets, referred to herein as sale of “e-used digital assets”. The term “e-used” is an anomaly, since digital assets do not have wear and tear. It is used herein to refer to a post-acquisition transaction in the form of sale or a loan of a digital asset that was previously purchased. For example, a consumer who purchased an electronic book (“e-book”) may, using the present invention, resell the e-book if he is no longer interested in owning it, at a price expected to be less than the price he originally paid for the e-book.

It will be appreciated by those skilled in the art that by enabling reselling of digital assets, the present invention enables a wide variety of commercial opportunities for post-acquisition transactions and revenue. Referring to the e-book example, prior art e-book e-commerce systems enable publishers to sell e-books through e-tailers, such as Amazon, Barnes and Noble, Border's, Apple iBooks, and Google e-Books, through the e-tailer's on-line stores, for presentation on e-book readers. Thus e-tailer Amazon sells e-books through its on-line store for the KINDLE®, e-tailer Barnes & Noble sells e-books through its on-line store for the NOOK®, and e-tailer Apple sells e-books through its on-line store for the IPAD®. Each publisher distributes its books through a single e-tailer, and the e-tailers disburse royalty payments to the respective publishers as the publishers' e-books are sold.

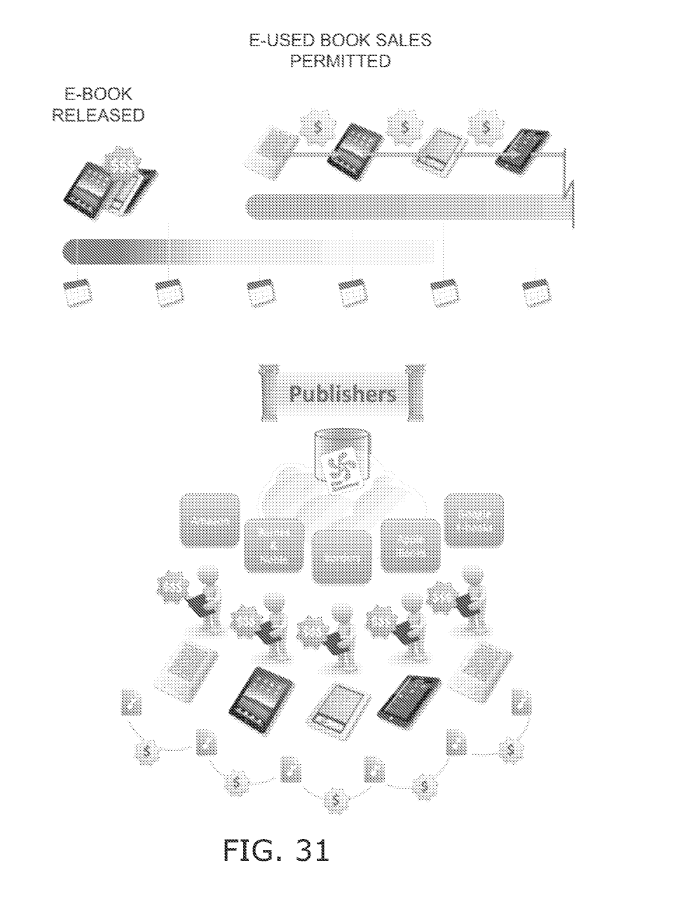

Reference is made to FIG. 31, which is an illustration of participants in a two-tier e-commerce system for selling e-books, in accordance with an embodiment of the present invention. As shown in FIG. 31, the present invention enables a robust e-used books market by (i) providing a registry across e-tailers of e-books (a “registry of registries”) for initial purchases of e-books, (ii) providing for subsequent sales of e-books across e-tailers, (iii) tracking sales transactions, and (iv) serving as a disparate vendor clearinghouse.

The present invention enables second digital tiers, for generating post-acquisition revenues for publishers, e-tailers and consumers, through sale of e-used book. The second tier allows consumers to sell their purchased e-books to other consumer across e-tailers. The second tier is controlled by the publishers, and may be triggered by specific events such as time from initial e-book release, number of initial e-books sold, revenue generated from initial e-book sales, and arrival of a designated date. The second tier allows publishers to re-monetize e-books multiple times after an initial sale, and to better target the consumer market through multiple e-tailers.

Using the present invention, a publisher can permit e-tailers to offer one or more of its e-books for resale, as an e-used book, by issuing a resale permission instruction to the registry of registries. Upon receiving the resale permission instruction, the e-tailer who initially sold the one or more e-books notifies the consumers, via its on-line store, of the opportunity to resell the one or more e-books. In turn, an interested consumer indicates his willingness to resell his e-book, and the e-used book is registered as being for sale across multiple e-tailers. Thus a consumer is able to purchase the e-used book through an e-tailer, from a consumer who initially purchased the e-book through a different e-tailer.

A typical use case scenario is as follows.

i. John purchases the e-book “Roots”, published by Vanguard Press, from Amazon for his KINDLE® in January 2010.
ii. Vanguard Press issues a resell permission instruction for Roots on Nov. 1, 2010, and Amazon posts a notification that Roots may be resold.
iii. John decides to resell his copy of Roots the $7.99, of which he would receive $1.99, on Nov. 5, 2010, and John's e-used book Roots is entered for sale across multiple e-tailers.
iv. Jane, who has a NOOK®, sees John's e-book for sale as an e-used book on her NOOK®, and decides to purchase it for $7.99 on Nov. 6, 2010, which she pays to Barnes and Noble. The $7.99 is allocated as shown in TABLE II.

TABLE II
Allocation of e-Used Book Revenue

| | | E-Used Price | $7.99 |
|---|---|---|---|
| Publisher | Vanguard Press | 30% | $2.40 |
| Initial Selling e-Tailer | Amazon | 15% | $1.20 |
| Consumer | John | 25% | $2.00 |
| e-Used Selling e-Tailer | Barnes & Noble | 20% | $1.60 |
| Registration, Tracking | Catch Media | 10% | $0.79 |
| and Clearing Provider | | | |

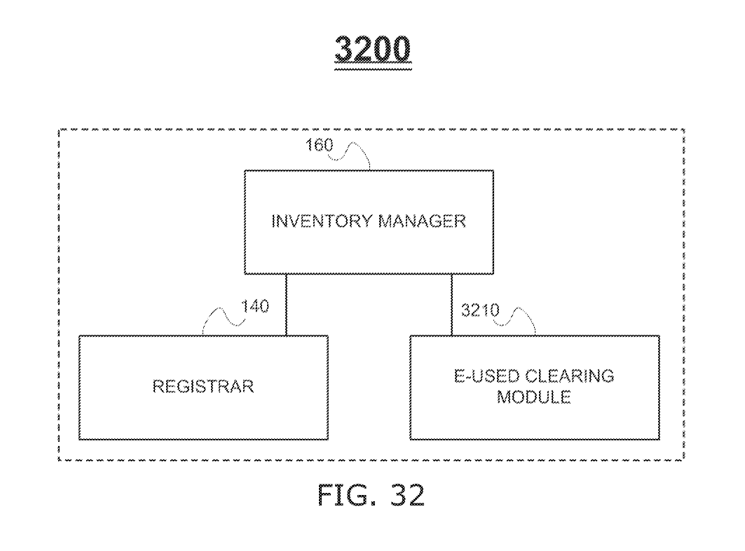

Reference is made to FIG. 32, which is a simplified block diagram of a system 3200 for resale of digital assets, in accordance with an embodiment of the present invention. Shown in FIG. 32 are registrar 140, inventory manager 160, and an e-used clearing module 3210. Registrar 140 registers purchase of a digital asset by a first consumer, C1 from a first e-tailer, E1. The digital asset is published by a publisher, P. The digital asset may be inter alia an e-book, a video, a song, a game or a software application. Customer C1 owns one or more first devices, D1, which present the digital asset to him.

In response to a resale permission instruction from publisher P, e-tailer E1 notifies customer C1 that he has permission to offer the digital asset for re-sale, as an e-used digital asset. Subsequently, in response to receipt of a resale request instruction from customer C1, the e-used digital asset is advertised for resale on the on-line stores of a plurality of e-tailers. Upon resale of the e-used digital asset by an e-tailer, E2, who may or may not be the same e-tailer as E1, registrar 140 registers purchase of the e-used digital asset. The purchaser of the e-used digital asset may be a second consumer, C2, who owns one or more second devices, D2, which present the digital asset to him. Alternatively, the purchaser of the e-used digital asset may be an e-tailer.

The price paid by the purchaser of the e-used digital asset is expected to be less than the initial price paid by C1 for the e-book. However, this not be the case, and in certain circumstances the price paid for the e-used digital asset may be the same as or higher than the initial price paid by C1.

Upon sale of the e-used digital asset, e-used clearing module 3210 prevents the at least one first device D1 from presenting the digital asset. E-used clearing module also determines allocation of the price paid for the e-used digital asset among at least participants C1, P, E1, E2 and a service provider who provides system 3200; e.g., as in TABLE II. Alternatively, consumer C1 may be allocated a credit towards purchase of digital assets, by publisher P, or by e-tailer E1, or by e-tailer E2, instead of cash.

At publisher P's discretion, the resale permission instruction may be automatically generated by registrar 140 upon occurrence of a trigger event. The trigger event may be inter alia, (i) sales of the digital asset reach a designated number of copies, (ii) sales of the digital asset achieve a designated revenue, (iii) a designated time period from the first release date of the digital asset has transpired, and (iv) a designated date has arrived. The trigger event may be a logical combination of events (i)-(iv).

At consumer C1's discretion, the resale request instruction may be automatically generated in response to publisher P's resale permission instruction. As such, consumer C1 can register in advance to re-sell his digital asset as soon as publisher P grants permission to do so.

In accordance with an embodiment of the present invention, a resold digital asset may be further resold, up to a designated maximum number of times. Thus, consumer C1 may sell his digital asset as an e-used digital asset to consumer C2; and consumer C2 may later resell his e-used digital asset to a consumer C3. The inherent limit on the maximum number of times the digital asset may be resold drives the selling price down, each successive sale.

In one embodiment of the present invention, publisher P's resale permission instruction may prescribe one or more limitations, such as a prescribed limit on the total number of consumers who may resell the digital asset. In such case, registrar 140 only enables consumer C1 to resell his digital asset when the number of other consumers already enabled to resell the digital asset is less than the prescribed limit.

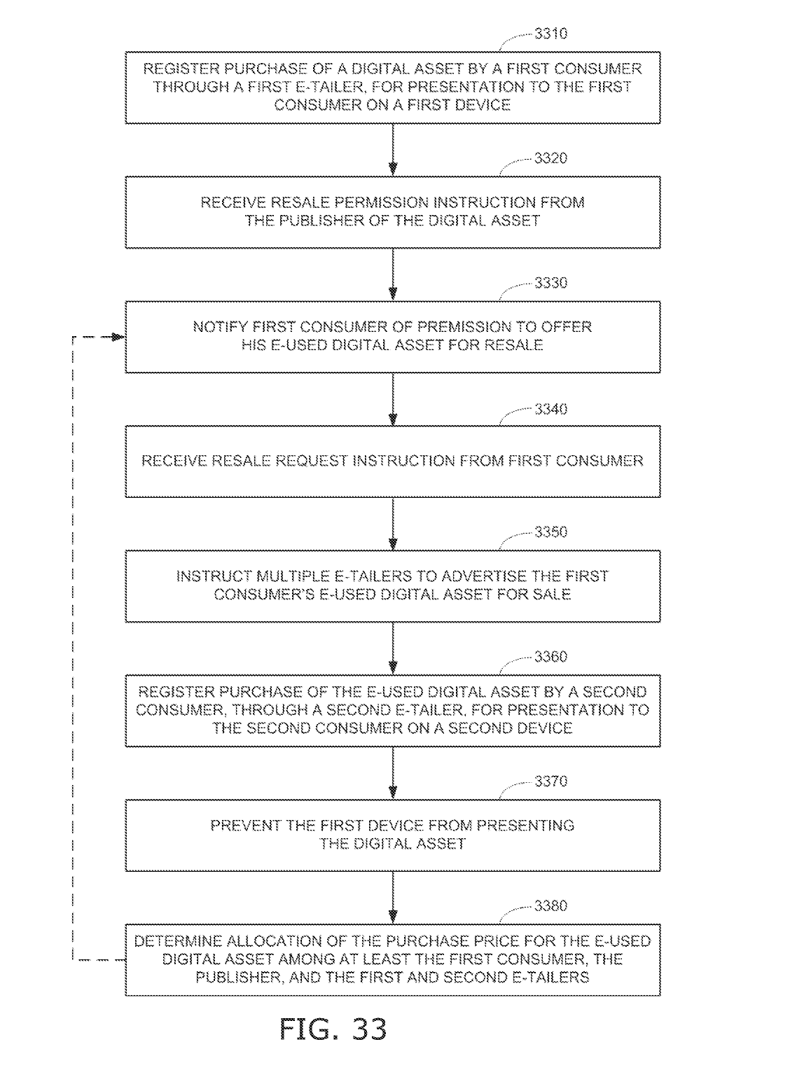

Reference is made to FIG. 33, which is a simplified flowchart of a method for resale of digital assets, in accordance with an embodiment of the present invention. At step 3310 the purchase of a digital asset by a first consumer, C1, through a first e-tailer, E1, for presentation to consumer C1 on a first device, D1, or on a plurality of first devices, is registered. At step 3320 a resale permission instruction is received from the publisher, P, of the digital asset. The resale permission instruction may be manually generated by publisher P or, at publisher P's discretion, may be automatically generated upon occurrence of a trigger event. The trigger event may be inter alia, (i) sales of the digital asset reach a designated number of copies, (ii) sales of the digital asset achieve a designated revenue, (iii) a designated time period from the first release date of the digital asset has transpired, and (iv) a designated date has arrived. The trigger event may be a logical combination of events (i)-(iv).

At step 3330 consumer C1 is notified that he has permission to resale his digital asset, as an e-used digital asset. At step 3340 a resale request instruction is received from consumer C1. The resale request instruction may be manually generated by consumer C1 or, at consumer C1's discretion, may be automatically generated in response to publisher P's resale permission instruction. As such, consumer C1 can register in advance to re-sell his digital asset as soon as publisher P grants permission to do so. At step 3350 multiple e-tailers are instructed to advertise consumer C1's e-used digital asset for sale.

Upon purchase of the e-used digital asset by a buyer, the purchase is registered at step 3360. The buyer may be a second consumer who buys the e-used digital asset through a second e-tailer, E2, not necessarily the same e-tailer as E1, or the buyer may be one of the e-tailers.

At step 3370 device D1 is prevented from presenting the digital asset. Step 3370 may be performed by removing the digital asset from device D1. Alternatively, step 3370 may be performed by disabling device D1 from presenting the digital asset.

At step 3380 an allocation of the purchase price paid for the e-used book is determined among at least publisher P, consumer C1 and e-tailers E1 and E2, such as the sample allocation shown in TABLE II. Alternatively, consumer C1 may be allocated a credit towards purchase of digital assets, by publisher P, by e-tailer E1 or by e-tailer E2, instead of cash.

In one embodiment of the present invention, publisher P's resale permission instruction may prescribe one or more limitations, such as a prescribed limit on the total number of consumers who may resell the digital asset. In such case, consumer C1 is only enabled at step 3330 to resell his digital asset when the number of other consumers already enabled to resell the digital asset is less than the prescribed limit.

As shown by the dashed arrow in FIG. 33, steps 3330-3380 may be repeated up to an allowed maximum number of times, thereby enabling the digital asset to be resold by successive buyers multiple times. Thus, consumer C1 may sell his digital asset as an e-used digital asset to consumer C2; and consumer C2 may later resell his e-used digital asset to a consumer C3. The inherent limit on the maximum number of times the digital asset may be resold drives the selling price down, each successive sale.

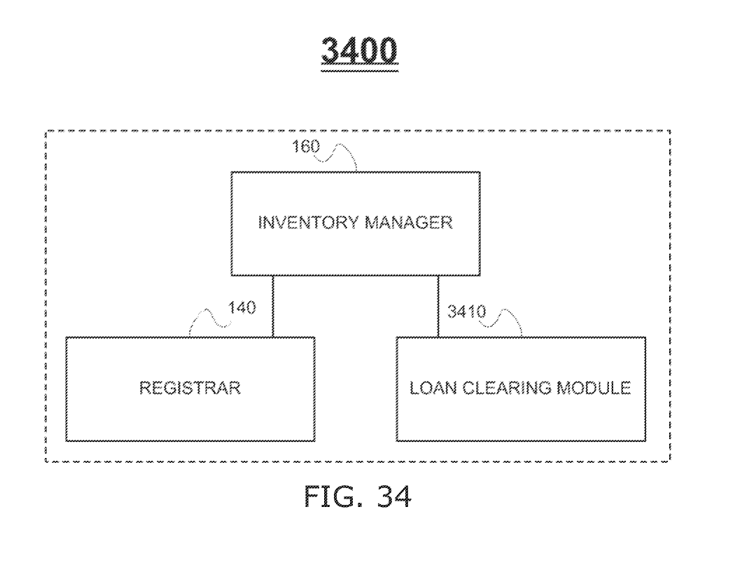

The present invention is also of advantage in providing a system for lending digital assets, whereby a first consumer, C1, lends his digital asset to a second consumer, C2, for the duration of a loan period, for a lending fee. Reference is made to FIG. 34, which is a simplified block diagram of a system for lending of digital assets, in accordance with an embodiment of the present invention. Shown in FIG. 34 are registrar 140, inventory manager 160, and a loan clearing module 3410. Registrar 140 registers purchase of a digital asset by a first consumer, C1 from an e-tailer, E. The digital asset is published by a publisher, P. The digital asset may be inter alia an e-book, a video, a song, a game or a software application. Consumer C1 owns one or more first devices, D1, which present the digital asset to him.

Upon issuance of a lending permission instruction from publisher P, consumer C1 is enabled to offer the digital asset for loan to another designated or undesignated consumer. The loan extends for a specific loan period, and requires payment of a lending fee. Upon exercise of the loan to a consumer, C2, registrar 140 registers the loan of the digital asset to consumer C2, for presentation on one or more second devices D2. In turn, loan clearing module 3420 prevents device D1 from presenting the digital asset for the duration of the loan period, and enables device D2 to present the digital asset. Loan clearing module 3420 determines an allocation of the lending fee paid by consumer C2 among at least publisher P, consumer C1 and e-tailer E.

After termination of the loan period, loan clearing module re-enables device D1 to present the digital asset, and prevents device D2 from further presenting the digital asset.

At publisher P's discretion, the lending permission instruction may be automatically generated by registrar 140 upon occurrence of a trigger event. The trigger event may be inter alia, (i) sales of the digital asset reach a designated number of copies, (ii) sales of the digital asset achieve a designated revenue, (iii) a designated time period from the first release date of the digital asset has transpired, and (iv) a designated date has arrived. The trigger event may be a logical combination of events (i)-(iv).

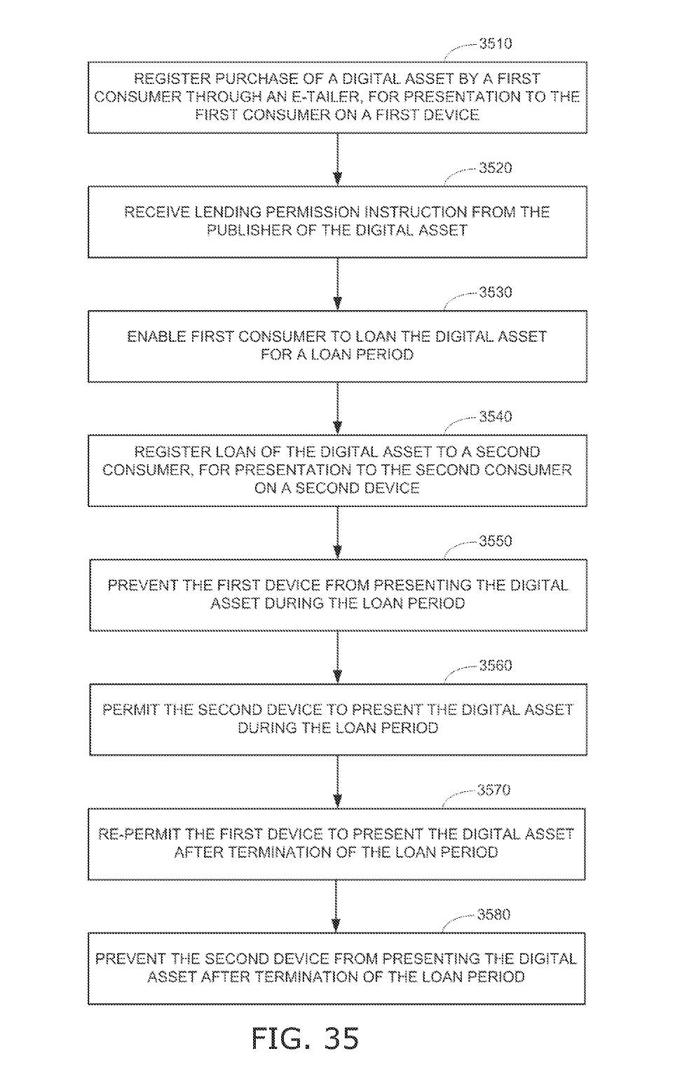

Reference is made to FIG. 35, which is a simplified flowchart of a method for lending digital assets, in accordance with an embodiment of the present invention. At step 3510 the purchase of a digital asset by a first consumer, C1, through an e-tailer, E, for presentation to consumer C1 on a first device, D1, or on a plurality of first devices, is registered. At step 3520 a lending permission instruction is received from the publisher, P, of the digital asset. The lending permission instruction may be manually generated by publisher P or, at publisher P's discretion, may be automatically generated upon occurrence of a trigger event. The trigger event may be inter alia, (i) sales of the digital asset reach a designated number of copies, (ii) sales of the digital asset achieve a designated revenue, (iii) a designated time period from the first release date of the digital asset has transpired, and (iv) a designated date has arrived. The trigger event may be a logical combination of events (i)-(iv).

At step 3530 consumer C1 is enabled to loan the digital asset to a designated or undesignated consumer. Upon exercise of the loan to a second consumer, C2, for presentation to consumer C2 on a second device D2, or on a plurality of second devices, the loan is registered at step 3540.

At step 3550 device D1 is prevented from presenting the digital asset for the duration of the loan period. Step 3550 may be performed by removing the digital asset from device D1. Alternatively, step 3550 may be performed by disabling device D1 from presenting the digital asset. At step 3560 device D2 is permitted to present the digital asset, for the duration of the loan period. Step 3560 may include providing the digital asset to device D2 for storage thereon.

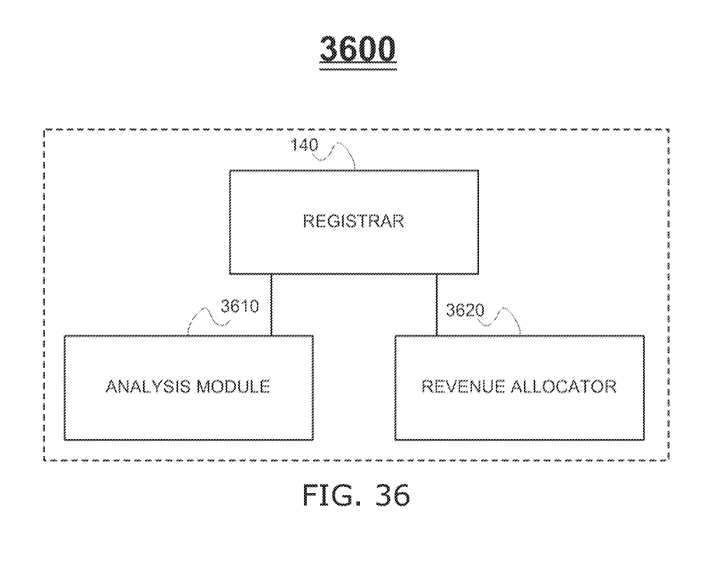

At step 3580 device D1 is re-permitted to present the digital asset, after termination of the loan period. At step 3590 device D2 is prevented from further presenting the digital asset, after termination of the loan period. The present invention is also of advantage in providing a market for buying and selling e-used digital asset, and determining an appropriate market price therefor. Reference is made to FIG. 36, which is a simplified block diagram of a system for determining a market price for a digital asset, in accordance with an embodiment of the present invention. Shown in FIG. 36 is registrar 140, an analysis module 3610 and a revenue allocator 3620. Registrar 140 registers one or more offers to sell a digital asset, by respective one or more consumers who purchase the digital asset through an e-tailer, E, and who obtained permission from the publisher, P, of the asset to resell the digital asset. Registrar 140 also registers one or more offers to buy the digital asset by respective one or more potential buyers.

Analysis module 3610 analyzes the offers to sell and offers to buy which were registered by registrar 140, and determines a price for the digital asset based on supply and demand. Revenue allocator 3620 allocates the revenue among at least publisher P, e-tailer E and the sellers.

Publisher P may constrain the resell price; e.g., publisher P may require that the price be at least $2.00.

Analysis module 3610 also determines a priority order for processing the offers to sell, based on one or more of the following factors: (i) the respective prices of the offers to sell, (ii) the order in which the offers to sell were registered by registrar 140, and (iii) the selling or buying history of the respective one or more consumers making the offers to sell.

In accordance with an embodiment of the present invention, each offer to sell may include a respective number of copies of the digital asset offered for sale. Analysis module 3610 may also base the priority order to processing the offers to sell on (iv) the respective number of copies of the digital asset offered for sale in each offer to sell.

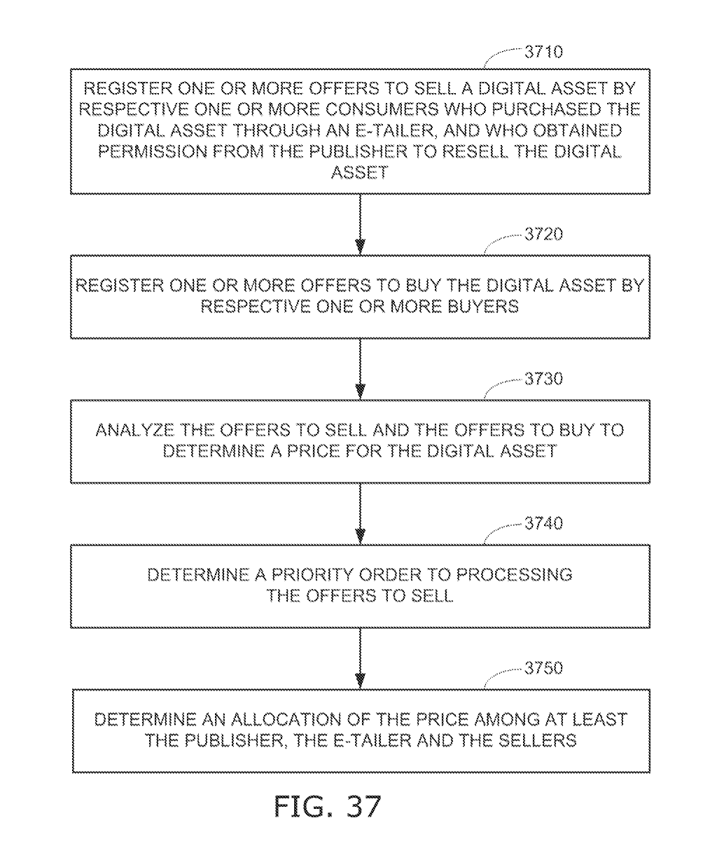

Reference is made to FIG. 37, which is a simplified flowchart of a method for determining a market price for a digital asset, in accordance with an embodiment of the present invention. At step 3710 one or more offers to sell a digital asset by respective one or more consumers who purchased the digital asset through an e-tailer, and who obtained permission from the publisher of the digital asset to resell the digital asset, are registered. At step 3720 one or more offers to buy the e-used digital asset by respective one or more potential buyers are registered.

At step 3730 the offers to sell and the offers to buy that were registered, are analyzed to determine a price for the digital asset based on supply and demand. At step 3740 a priority order to processing the offers to sell is determined, based on one or more of the following factors: (i) the respective prices of the offers to sell, (ii) the order in which the offers to sell were registered, and (iii) the selling or buying history of the respective one or more consumers making the offers to sell.

In accordance with an embodiment of the present invention, each offer to sell may include a respective number of copies of the digital asset offered for sale. Step 3740 may also be based on (iv) the respective number of copies of the digital asset offered for sale in each offer to sell.

At step 3750 the price paid for the digital asset by the potential buyers is allocated as least among the publisher, the e-tailer and the sellers.

### Campaign Manager

In accordance with an embodiment of the present invention, there is provided a campaign manager in the form of a system that provisions “campaign content” to a “device platform” based on “rules”. The campaign content includes static media, interactive media, or interactive applications. Campaign content may be provisioned once, or may be provisioned in subscription form; e.g., every x days/weeks/months, for y times, campaign content may be pushed to target devices based on the rules.

The device platforms include any application, whether PC, mobile, web or embedded.

The rules are based on criteria including properties of the device or platform that the campaign content is provisioned to, based on media-related or non-media-related tracking data for a consumer. As such, campaigns are provisioned based on any aspect of a consumer's “media universe”—inter alia what he owns, what he consumes, what he shares, what he borrows, when he consumes, how much he consumes, and on what devices or apps he does this.

Consumption data from within the campaigns is also tracked and is fed back into the campaign rules system. As such, interactions a consumer has had in the past with a campaign can drive additional campaigns. Interaction may be viewing (impressions), clicking through, consuming media, clicking out to external sites, or purchasing.

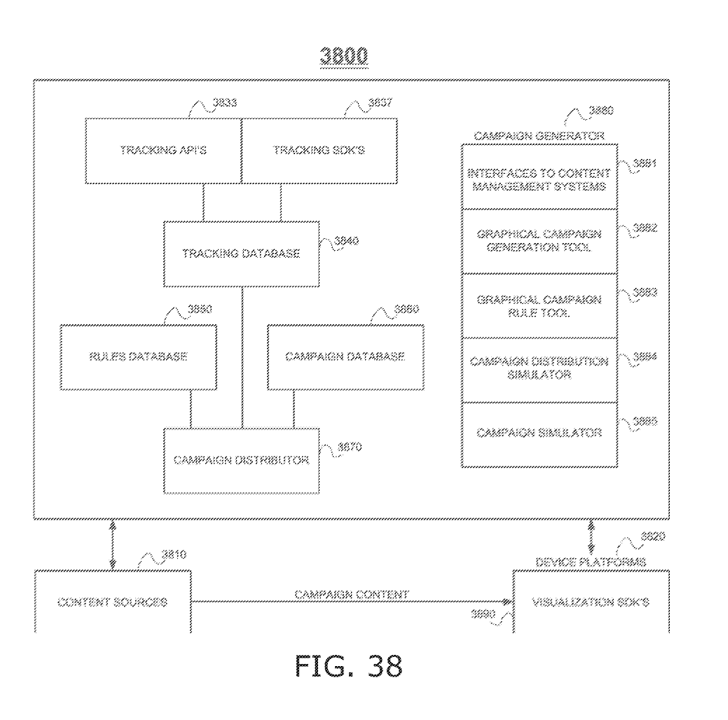

Reference is made to FIG. 38, which is a simplified block diagram of a campaign manager 3800 for provisioning campaign content from content sources 3810 to device platforms 3820, in accordance with an embodiment of the present invention. Campaign manager 3800 distributes campaign content to device platforms based on a set of rules. Campaign content includes the content types provided in TABLE III below, device platforms include the device platform types provided in TABLE IV below, and rules include rules based on the rules criteria provided in TABLE V below.

Campaign manager 3800 includes tracking APIs 3833, which enable third party sites, systems and applications to provide tracking data to campaign manager 3800. Campaign manager includes tracking SDK's 3837 for different platforms, including mobile applications and PC applications, which enable third party applications to provide tracking data to campaign manager 3800. Campaign manager includes a tracking database 3840 for storing and managing device data, consumer data and consumption data obtained via tracking APIs 3833 and tracking SDKs 3837.

Campaign manager 3800 includes a rules database 3850 for storing and managing representations of the rules specified for distribution of campaigns. Campaign manager 3800 includes a campaign database 3860 for storing and managing campaigns that have been generated.

Campaign manager 3800 includes a campaign distributor 3870, which distributes campaigns to enables client devices and applications; i.e., to clients or applications that have integrated tracking API's 3833 or tracking SDK's 3837, and visualization SDK's 3850. Campaign distributor 3870 distributes campaigns in accordance with campaigns in campaign database 3860, rules in rules database 3850, and tracking data in tracking database 3840.

Campaign manager 3800 includes a campaign generator 3880. Campaign generator 3880 includes interfaces 3881 to content management systems; a graphical campaign generation tool 3882 for identifying content from one or more content management systems and for defining a campaign in terms of the identified content, a graphical campaign rule tool 3883 for defining distribution rules for campaigns based on tracking data, a campaign distribution simulator 3884 for creating simulations of distributions based on actual tracking data and hypothetical rules, and a campaign simulator 3885 for simulating visualization of campaigns running on applications.

Device platforms 3820 includes visualization SDKs 3890 for different platforms, including mobile applications and PC applications, which enable applications running on these platforms to receive campaigns from campaign manager 3800, to render the received campaigns in their native GUI environments, and to provide user interactivity as specified by the campaigns being rendered.

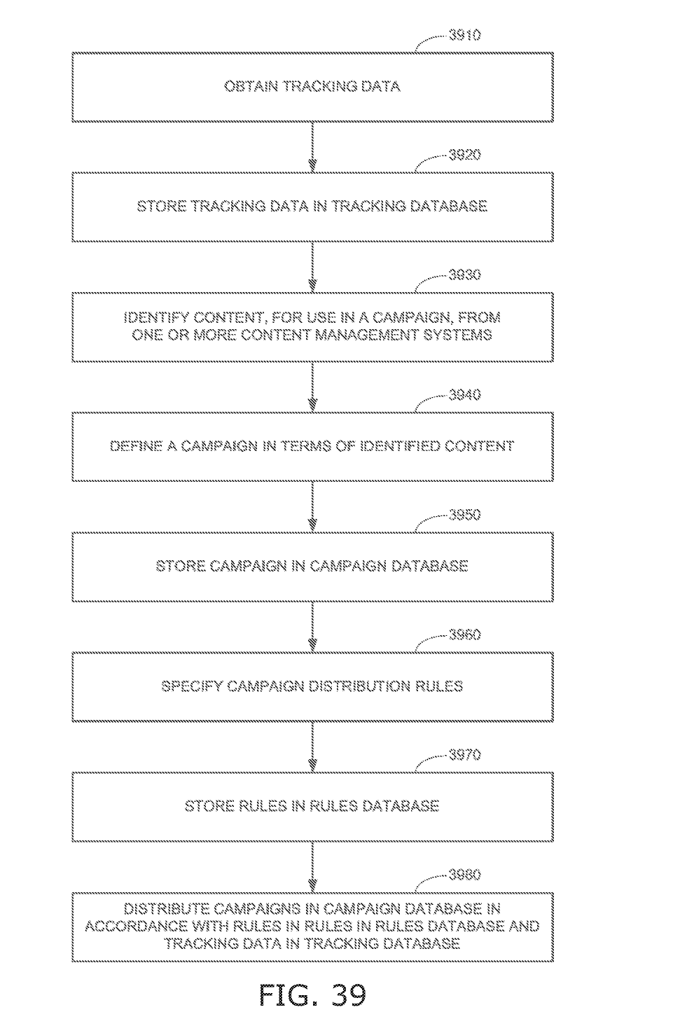

Reference is made to FIG. 39, which is a flowchart of a method for managing provision of campaign content from content sources to device platforms, in accordance with an embodiment of the present invention.

TABLE III
Campaign Content Types

| | |
|---|---|
| C1 | audio media, such as music or audiobooks |
| C2 | video media, such as movies, shows and music videos |
| C3 | textual media, such as eBooks |
| C4 | rich content, such as HTML combined with various types of media |
| C5 | interactive content |
| C6 | widgets |
| C7 | applications |

TABLE IV
Device Platform Types

| | |
|---|---|
| D1 | applications on mobile devices |
| D2 | applications on personal computers |
| D3 | web applications |
| D4 | embedded applications |

TABLE V
Rule Criteria

| | |
|---|---|
| | rules based on device-specific/application-specific criteria |
| R1 | device types |
| R2 | operating systems |
| R3 | applications on devices |
| R4 | devices distributed by a particular retailer |
| R5 | devices distributed by a retailer as part of a specific other |
| | product or service |
| | rules based on consumer -specific criteria |
| R6 | consumer demographics |
| R7 | media access services subscribed to by a consumer |
| R8 | media subscription services subscribed to by a consumer |
| R9 | other services subscribed to by a consumer |
| R10 | media owned by a consumer |
| R11 | media consumed by a consumer |
| R12 | media shared by a consumer |
| R13 | devices owner by a consumer |
| | campaign tracking data for a consumer: |
| R14 | campaigns deployed to consumer devices |
| R15 | campaigns viewed |
| R16 | campaign click-through events |
| R17 | campaign click-out events, i.e., clicks out to a third party URL |
| R18 | campaign media view events |
| R19 | campaign interactions, i.e., click interaction within an |
| | interactive campaign |
| R20 | purchases of media or other products via a campaign |

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

1. A campaign management system, comprising:
tracking interfaces for receiving consumer media-related tracking data;
a tracking database, coupled with said tracking interfaces, for storing and managing data received via said tracking interfaces;
a campaign generator for generating campaigns, comprising:
content interfaces to content management systems;
a generation tool for identifying content for use in a campaign via said content interfaces, and for defining a campaign in terms of the identified content; and
a rule tool for defining rules for campaigns in terms of tracking data;
a campaign database, coupled with said campaign generator, for storing campaigns that have been generated;
a rules database, coupled with said campaign generator, for storing and managing rules governing distribution of campaigns; and
a campaign distributor, coupled with said campaign database, said rules database and said tracking database, for distributing campaigns in said campaign database to client media devices in accordance with rules in said rules database and tracking data in said tracking database.

2. The campaign management system of claim 1 wherein said campaign generator further comprises a campaign simulator to simulate visualization of campaigns running on applications.

3. The campaign management system of claim 1 wherein said campaign generator further comprises a campaign distribution simulator, for simulating distribution of campaigns based on tracking data in said tracking database and hypothetical rules.

4. The campaign management system of claim 1 wherein rules governing distribution of campaigns comprise rules based on one or more of the following criteria: device types, device operating systems, applications on devices, devices distributed by a particular retailer, and devices distributed by a retailer as part of a specific product or service.

5. The campaign management system of claim 1 wherein rules governing distribution of campaigns comprise rules based on one or more of the following criteria: consumer demographics, media access services subscribed to by a consumer, media owned by a consumer, media consumed by a consumer, media shared by a consumer and devices owned by a consumer.

6. The campaign management system of claim 1 wherein rules governing distribution of campaigns comprise rules based on one or more of the following criteria: campaigns provisioned to consumer devices, campaigns viewed, campaign click-through events, campaign click-out events, campaign media view events, campaign interactions, and purchases of media or other products via campaigns.

7. The campaign management system of claim 1 wherein content identified by said campaign generator comprise one or more of the following: audio media including music and audio books, video media including movies, shows and music videos, text media including e-books, rich content including HTML combined with media, interactive content, widgets and applications.

8. A method for managing provisioning of campaigns to consumer media devices, comprising:
obtaining consumer media-related tracking data;
storing the obtained tracking data in a tracking database;
identifying content for use in a campaign, from one or more content management systems;
defining a campaign in terms of the identified content;
storing the defined campaign in a campaign database;
specifying campaign distribution rules in terms of tracking data;
storing the specified distribution rules in a rules database; and
distributing campaigns stored in the campaign database to client media devices, in accordance with rules stored in the rules database and tracking data stored in the tracking database.

9. The method of claim 8 wherein campaign distribution rules comprise rules based on one or more of the following criteria: device types, device operating systems, applications on devices, devices distributed by a particular retailer, and devices distributed by a retailer as part of a specific product or service.

10. The method of claim 8 wherein campaign distribution rules comprise rules based on one or more of the following criteria: consumer demographics, media access services subscribed to by a consumer, media owned by a consumer, media consumed by a consumer, media shared by a consumer and devices owned by a consumer.

11. The method of claim 8 wherein campaign distribution rules comprise rules based on one or more of the following criteria: campaigns provisioned to consumer devices, campaigns viewed, campaign click-through events, campaign click-out events, campaign media view events, campaign interactions, and purchases of media or other products via campaigns.

12. The method of claim 8 wherein identified content comprises one or more of the following: audio media including music and audio books, video media including movies, shows and music videos, text media including e-books, rich content including HTML combined with media, interactive content, widgets and applications.

13. The campaign management system of claim 1 wherein said tracking interfaces receive the consumer media-related tracking data from a third party.

14. The method of claim 8 wherein said obtaining obtains the consumer media-related tracking data from a third party.
